(19) United States
(12) Patent Application Publication
(10) Pub. No.: US 2001/0042002 A1
(43) Pub. Date: Nov. 15, 2001

(54) METHOD AND SYSTEM FOR COMMUNICATING TARGETED INFORMATION

(76) Inventor: JEFF KOOPERSMITH, ATLANTIC HIGHLANDS, NJ (US)

Correspondence Address: Underwriters Digital Research, Inc., 119 Australian Avenue, Suite Five, Palm Beach, FL, 33480, US

(21) Appl. No.: 09/385,200

(22) Filed: Aug. 30, 1999

(51) Int. Cl. G06F 17/60

(52) U.S. Cl. 705/10; 705/14; 705/27

(57) ABSTRACT

A method of communicating information is provided in which a demographic profile for at least one of a plurality of consumers is formed. Next, an inquiry is received from at least one of the plurality of consumers. Next, data relating to the inquiry is retrieved and the data is filtered based on the demographic data associated with the at least one of the plurality of consumers. A response to the inquiry is customized according to the demographic data associated with the at least one of the plurality of consumers. Finally, the response is transmitted to the at least one of the plurality of consumers.

### FIELD OF THE INVENTION

The present invention relates to a method for communicating targeted information and, in particular, to a method for communicating targeted information in connection with a transaction.

### BACKGROUND OF THE INVENTION

The advent of networked communications, and in particular communications via the Internet, has radically changed the way consumers interact with suppliers of goods and services. This new model of commerce, often called e-commerce, includes how consumers investigate a particular product or service they wish to purchase, how suppliers advertise their wares to their target customer base and how the transaction between the consumer and the supplier is consummated. Where as previously consumer purchases were generally limited to those suppliers in the consumer's geographic area or remotely accessible, for example, via mail-order, the Internet has widened the consumer's buying opportunities to literally any supplier in the world. The consumer can now search the Internet for a product or service that meets the consumer's needs and purchase it from the supplier that offers the best deal.

Similarly, the Internet has changed the way suppliers of goods and services advertise in an effort to expand their customer base. Instead of being restricted to the high cost, inflexible and geographically limited print, radio and television advertisement mediums, the Internet has enabled advertisers to reach millions of potential customers using tools such as bulk e-mail and banner advertisements. Now, for little to no cost, suppliers can target a potential customer base that spans the globe.

An example of how a typical e-commerce transaction is consummated over the Internet is shown in FIGS. 1 and 2. A consumer 107, operating a computer 105 connected to a network 100 (for e.g., the Internet), wants to purchase a two slice toaster oven. Consumer 107 issues an information request 106 regarding two slice toaster ovens to a search server 111 that executes search engine software and that is connected to network 100. Search server 111 searches a database 113 of web site addresses (URLs) for web sites that include the words “two slice toaster oven.” If a match is found, search server 111 sends a reply 114 via network 100 to consumer 107 that includes the URLs of the web sites that include the words “two slice toaster oven.” Consumer 107 then browses the web sites indicated by search server 111 to locate a supplier 115 that is willing to sell a suitable two slice toaster oven.

Once consumer 107 has identified supplier 115 from which to purchase, consumer 107 sends a purchase request 126 to a supplier server 110, connected to network 100, that is used by supplier 115 to transact business with customers also connected to network 100. Purchase request 126 includes information such as a customer credit card number 125 and shipping instructions 140. Supplier server 110 communicates credit card number 125 via network 100 to financial clearinghouse 120 to determine whether consumer 107 has the available buying power to purchase the toaster oven. If sufficient buying power exists, financial clearinghouse 120 electronically transfers funds 130 to supplier 115 to cover the price of the toaster oven and debits the credit card of consumer 107. Then, supplier 115 completes the transaction by delivering the toaster oven to consumer 107 via delivery service 150.

Although access to a global e-commerce network opens up a wide range of opportunities for consumers and suppliers alike, there are several key deficiencies in the e-commerce model as it currently exists. Firstly, it is very often difficult for the consumer to find relevant and useful information about the product that the consumer would like to purchase and also difficult to find a suitable supplier of the product. The Internet search engine technology that is typically used to find such information generally provides hundreds of URLs in response to a query—far too many for the customer to review and many of which that are not relevant to the original search request. For example, a search done (on Aug. 26, 1999) on the phrase “two-slice toaster” using the HotBot™ search engine returned over 1400 responses including references to four slice toasters. Consequently, this prior art method of searching for product and purchasing information is ineffective.

Secondly, even if the consumer locates a supplier of the product, the present e-commerce transaction mechanism is flawed because it requires the consumer to divulge personal information to the supplier, including the customer's name, address, e-mail address and credit card information. The drawback in making such information available to suppliers is that it compromises the consumer's privacy because the supplier might use that information to send unsolicited messages to the consumer or sell the information to others that do so. Also, by providing credit card information to the supplier, the consumer is at risk that the credit card information may be stolen from the supplier and used for unauthorized purposes. While these concerns exists for suppliers with which the consumer has had previous dealings, they are magnified in situations where the consumer is dealing with a particular supplier for the first time.

Third, even if the consumer locates the product he must then again engage in several more searches to gain the best price for that product.

Another type of e-commerce transaction is known as the “reverse auction.” In a reverse auction, the consumer publishes to a plurality of suppliers a request to purchase a particular product or service at a particular price. If any of the suppliers desires to sell the product or service at the price specified by the consumer, that supplier responds to the consumer's request with an offer to sell that product or service at that price. The consumer then accepts a suitable offer and consummates the transaction.

A drawback of the reverse auction method is that the offering suppliers know nothing about the consumer, for example the consumer's demographic profile, buying habits or interests, other than the consumer's desire to purchase a product at a particular price. Because of this lack of information, the supplier is unable to suggest a better or more appropriate product or service to the consumer in response to the consumer's purchase request. For example, if the consumer issued a request for an airline ticket to Florida at a particular price, the offering supplier may offer, based on knowledge of the consumer's previous vacationing habits, a special deal for a ticket to Bermuda for the same price and also order a vegetarian meal for the flight based on the consumer's dietary constraints. The prior art reverse auction technique does not provide the offering supplier with this type of information about the consumer which would enable the supplier to compete by offering a higher level of service to consumers—and not by merely offering the lowest price. As a result, suppliers have little incentive to participate in reverse auction transactions.

A significant component of the e-commerce landscape is the ability of suppliers to use the Internet to advertise its products and services to a broad range of potential customers. One Internet-based advertising mechanism used by suppliers to reach potential customers is called “banner advertising.” Banner ads are typically placed on heavily trafficked Internet web sites and generally contain advertising copy touting the supplier's product or service. Additional information about the product may be obtained by “clicking” on the banner ad which usually points the potential customer to the web site of the supplier. Although banner ads are heavily used, their effectiveness has been placed in doubt by studies that have shown that a very small percentage of surfers actually click through the banner ads to the suppliers web site [See NUA Internet Surveys 1998-1999 And A.C. Nielsen Internet Reports].

Another advertising technique that has been made possible by the Internet is the use of bulk e-mailing services, as shown in FIG. 3. A bulk e-mailer 310 will receive a message 185 from an advertiser 182 that advertiser 182 wants to broadly distribute. Bulk e-mailer 310 then e-mails that message to a large list of e-mail addresses 305.1-305.n that bulk e-mailer 182 has assembled. The hope on the part of advertiser 182 is that some of the recipients of the e-mailed advertising message 185 will turn into customers of advertiser 182.

However, as has been well documented, the use of bulk e-mail as an advertising medium is severely flawed. First of all, the e-mail lists compiled by the bulk e-mailers generally do not contain much demographic information, if any, with which to direct the advertising message to a specific target market. Basically, the approach used is merely to “blast” the message to millions of e-mail addresses with the hope that even a fraction respond favorably. A more significant problem with the bulk advertising approach is that sending unsolicited messages, sometimes referred to as SPAM, is intrusive and very often unwelcome by the recipients. Consequently, the recipients generally ignore these unsolicited advertising messages, the result being that the bulk e-mail advertising approach not being very effective in reaching potential customers. Furthermore, there is an active movement to eliminate unsolicited e-mail from the Internet altogether.

In an attempt to overcome some of the deficiencies described above, other approaches to Internet based advertising have been proposed. One such approach is described in U.S. Pat. No. 5,794,210, issue to Goldhaber et al. which in effect gives the consumer a monetary reward for viewing a supplier's advertisement. The system disclosed in Goldhaber et al. stores a demographic profile of the consumer that is constructed from a questionnaire the consumer completes when subscribing to the service and which is updated based on the consumer's usage of the system. Upon logging into the system, the consumer is presented with a list of ads pre-selected based on the consumer's personal profile. The consumer is also presented with an image of a little gold coin, called a “Cybercoin,” that when clicked by the consumer opens up the ad for viewing and also causes a transfer of cash or credit to the consumer's account.

A drawback of Internet based advertising schemes, such as Goldhaber et al., that compensate consumers for viewing advertisements is that generally the consumer has not demonstrated any real interest in purchasing the product or service that is the subject of the advertisement. The consumer's motivation to view the advertisement is often merely to earn the monetary reward provided by the ad sponsor. This way of giving the consumer incentive to view an advertisement generally results in an uneconomical use of the ad sponsor's money.

In summary, the present e-commerce model is inefficient for a variety of reasons. First, it is difficult for a consumer to find focused information regarding a product the consumer desires to purchase and a suitable supplier from which to purchase the product. Second, the actual e-commerce transaction is flawed because it requires the consumer to divulge personal and financial information to suppliers in order to consummate the transaction. Finally, the techniques in use by suppliers to advertise their goods and services to potential customers is often intrusive, uneconomical and ineffective. Accordingly, it is desirable to provide an e-commerce environment that can be accessed via a global network, such as the Internet, that overcomes the deficiencies of the prior art e-commerce model.

### SUMMARY OF THE INVENTION

The present invention is directed to overcoming the deficiencies in the prior art. In accordance with the present invention, a method of communicating information is provided in which a demographic profile for at least one of a plurality of consumers is formed. Next, an inquiry is received from at least one of the plurality of consumers. Next, data relating to the inquiry is retrieved and the data is filtered based on the demographic data associated with the at least one of the plurality of consumers. A response to the inquiry is customized according to the demographic data associated with the at least one of the plurality of consumers. Finally, the response is transmitted to the at least one of the plurality of consumers.

In an exemplary embodiment, the demographic profile is formed by sending an initial questionnaire to the at least one of the plurality of consumers, receiving a reply to the initial questionnaire and incorporating the reply to the initial questionnaire into the demographic profile of the at least one of the plurality of consumers. The demographic profile is updated by sending at least one subsequent questionnaire to the at least one of the plurality of consumers, receiving a reply to the at least one subsequent questionnaire and incorporating the reply to the subsequent questionnaire into the demographic profile of the at least one of said plurality of consumers. The demographic profile is further updated by incorporating at least one inquiry from the at least one of the plurality of consumers into the demographic profile of the at least one of the plurality of consumers.

In an exemplary embodiment, the plurality of consumers are coupled to a network for engaging in communications via the network, and a system is coupled to the network so as to be in communication with the plurality of consumers for receiving an inquiry from any of the plurality of consumers and for transmitting a reply to the inquiry. In this embodiment, the demographic profile is further updated by monitoring the communications via the network of the at least one of the plurality of consumers and incorporating the communications via the network of at least one of the plurality of consumers into the demographic profile of the at least one of the plurality of consumers.

The present invention is also directed to a method for a consumer to purchase an article wherein the consumer, having a demographic profile, is in network communications with a trusted entity having a credit line. According to the method, an inquiry relating to the article is received from the consumer and a response to the inquiry is transmitted to the consumer. The response is based on the demographic profile of the consumer and includes a reference to at least one supplier of the article. Next, a request from the consumer to purchase the article from the at least one supplier is received. Next, the purchase of the article by the consumer is cleared to determine whether the consumer has sufficient purchasing power to purchase the article and, if so, a payment is received from the consumer for the article. Finally, the article is purchased from the supplier using the credit line of the trusted entity and is then is sent to the consumer.

In a preferred embodiment, the article is purchased from the supplier without disclosing to the supplier the identity of the consumer. In this embodiment, the supplier is directed to forward the article to a secure shipping entity. Then, the identity of the consumer is disclosed to the secure shipping entity and the secure shipping entity is directed to send the article to the consumer.

According to an exemplary embodiment of the invention, after a request to purchase the article is received from the consumer, a request for quotation is published to a plurality of suppliers of the article. In response to the request for quotation, a plurality of offers to sell the article are received and a comparison of the plurality of offers is provided to the consumer. Next, if an authorization to purchase the article from one of the plurality of suppliers is received from the consumer, the purchase is cleared and the article is purchased from the one of the plurality of suppliers using the credit line of the trusted entity. Finally, the article is delivered to the consumer.

In a preferred embodiment, the comparison of the plurality of offers includes an indication of which are the best offers based on a set of characteristics including, but not limited to, price, quality of article or delivery time, and also based on the demographic profile of the consumer.

In an exemplary embodiment, a counterbid is published to at least one of the plurality of suppliers and at least one counteroffer in response to the counterbid is received. Then, the consumer is provided with a comparison of the plurality of offers and the at least one counteroffer. Next, if an authorization to purchase the article from one of the plurality of suppliers is received from the consumer, the purchase is cleared and the article is purchased from the one of the plurality of suppliers using the credit line of the trusted entity. Finally, the article is delivered to the consumer.

Thus, according to the present invention, a consumer who wants information about a particular product or service that the consumer may want to purchase, issues a inquiry over a network, such as the Internet, to a system that receives the inquiry. The system then retrieves data relating to the product or service that the customer inquired about, such data including a description or advertisement relating to the product or service and/or suppliers of the product or service. The system then filters the data based on the demographic profile of the inquiring consumer so that a customized response to the inquiry is formed using data that is appropriate to the consumer. Thus, the advertising. literature or other information regarding the consumer's request is delivered in the form and at the time determined from the consumer profile. This allows the consumer to view anything from only price information to a five minute streaming video presentation on the product, the producer or the supplier.

Furthermore, if the consumer decides to purchase the product or service, the system provides the consumer with a choice of prices for that specific product or service . In addition, based on the consumer's preference, the system may also provide the consumer with a supplier or list of suppliers, that will sell the product or service. Once the consumer authorizes the system to purchase the product or service on behalf of the consumer at a particular price and the consumer's credit line is charged for the purchase, the system will consummate the transaction with the selected supplier using its own credit line and without disclosing the identity of the consumer to the supplier.

The present invention is also directed to a method of distributing advertising information to a targeted audience. In the first step of this method, a demographic profile is formed for each a plurality of consumers. This demographic profile is constructed through surveys of each of the plurality of consumers with over 1,500 questions on an initial survey, periodic update surveys and from tracking the consumer's movement around the internet as a reflection of interest. Next, advertising information is received from an advertising entity. Then, at least one of the plurality of consumers is selected to receive the advertising information based on the demographic profile associated with the at least one of the plurality of consumers if the at least one of the plurality of consumer opts-in to view it. Next, an advertising message is constructed from the advertising information according to the demographic profile associated with the at least one of the plurality of consumers. Finally, the advertising message is transmitted to the at least one of the plurality of consumers. As a result, only those consumers that have expressed an interest in a particular product or service or a range of products and services will receive an advertising message regarding that product or service while the consumers that are not interested in the product or service will not receive an unwanted advertising message. Further, consumers are rated on their ability to purchase the goods and services and are thus pre-qualified to receive advertising for the specific product or service thus saving advertisers from spending advertising budgets on improbable potential customers.

The invention accordingly comprises the several steps and the relation of one or more of such steps with respect to each of the others thereof, which will be exemplified in the method hereafter disclosed, and the scope of the invention will be indicated in the claims.

### BRIEF DESCRIPTION OF THE DRAWING

For a fuller understanding of the invention, reference is had to the following description taken in connection with the accompanying drawings, in which:

FIG. 1 is a block diagram of a prior art method of searching for information over the Internet;

FIG. 2 is a block diagram of a prior art method of conducting an e-commerce transaction on the Internet;

FIG. 3 is a block diagram of a prior art method of distributing advertising information over the Internet;

FIG. 4 is a block diagram of a method of conducting transactions in a networked environment in accordance with the present invention;

FIG. 5 is a block diagram of a trusted entity and a consumer data record in accordance with the present invention;

FIG. 6 is a block diagram showing the method by which a search request from a consumer is fulfilled in accordance with the present invention;

FIG. 7 is a block diagrams showing an e-commerce transaction conducted in accordance with the present invention;

FIG. 8 is a block diagram showing the flow of consumer identification information in the e-commerce transaction of FIG. 7;

FIG. 9 is a block diagram shown the method by which a supplier for the product or service requested by a consumer is determined using a bidding process;

FIG. 10A-10C are blocks diagram showing a method by which a trusted entity server of the present invention negotiates with suppliers to get the best deal for a consumer;

FIG. 11 is a block diagram showing a method of providing targeted advertising in accordance with the present invention; and

FIG. 12 is a block diagram showing the flow of information in the method of FIG. 11.

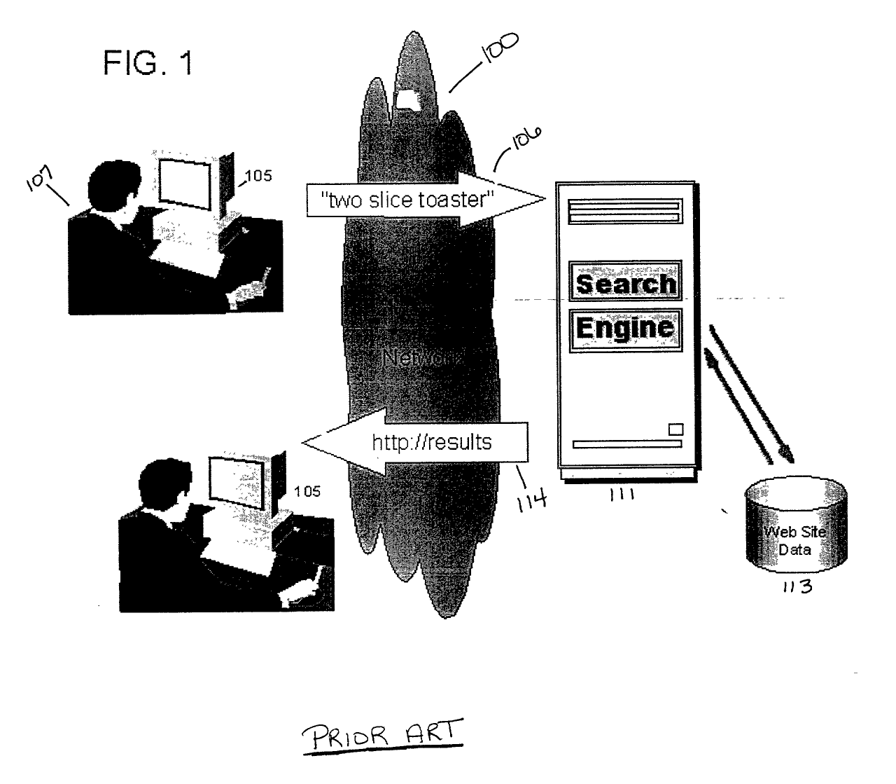

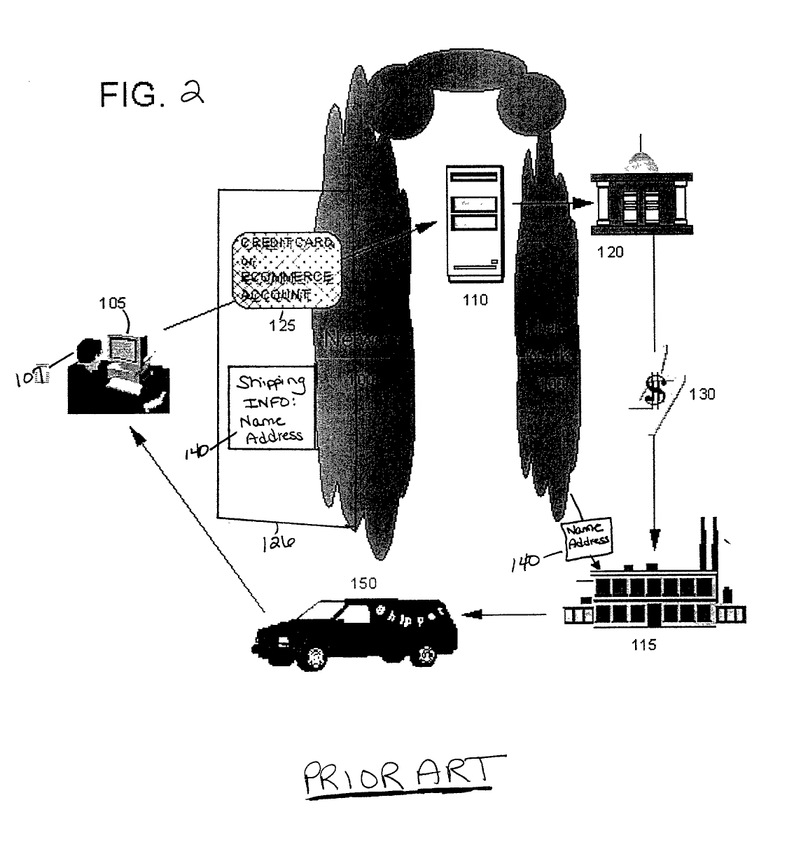

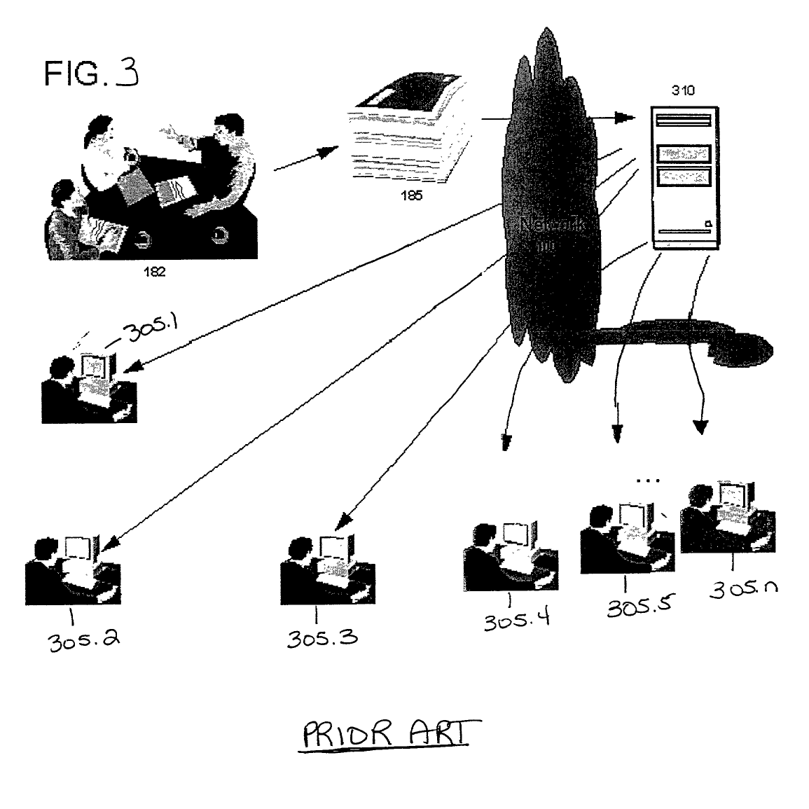

### DESCRIPTION OF THE PREFERRED EMBODIMENTS

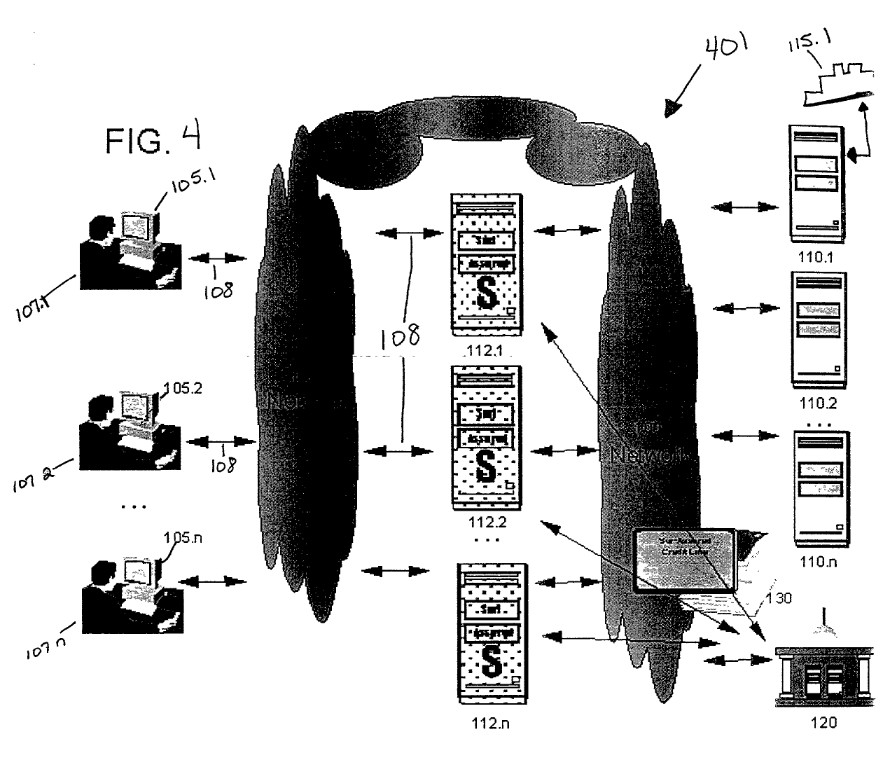

Referring now to FIG. 4, there is shown a block diagram of a method of conducting transactions in a networked environment 401 in accordance with the present invention. Networked environment 401 includes a network 100, which may be any communications medium including, but not limited to, the Internet. Included in networked environment 401 are a plurality of consumer devices 107 operated by a plurality of consumers 107.1-107.n, respectively, and each of which being in communication with network 100 via a communications link 108. Consumer devices 105.1-105.n can be any device that allows connection to network 100 including, but not limited to, a personal computer containing a modem and executing communications software. Where network 100 is the Internet, consumer device 105 could, for example, communicate with network 100 using web browser software. Communications link 108 used by consumer devices 105 to communicate with network 100 can include, by way of non-limiting example, a dial-up connection, an ISDN line, DSL, T1 line or any other suitable link. In an exemplary embodiment, consumer device 105 is mobile, for example a hand held device, that communicates with network 100 via a wireless connection.

Also connected to network 100 is at least one trusted entity server 112. Trusted entity server 112 includes a central processor that executes a computer program that performs the functions that will be described below. Trusted entity server 112 also includes a communications device, such as a modem, for connecting to network 100 via communications link 108. Once trusted entity server 112 and consumer devices 105 connect to network 100, trusted entity server 112 and consumer devices 105 can freely communicate with each other via network 100.

A plurality of supplier servers 110, associated with a plurality of suppliers 115, are connected to network 100 so as to be in communication with trusted entity server 112. Supplier servers 110 include a database of information relating to the product and/or services offered by suppliers 115, including, by way of non-limiting example, product description, product reviews, delivery schedule, price and warranty information.

Also included in networked environment 401 is a financial clearinghouse 120 that communicates with trusted entity server 112 via network 100. Financial clearinghouse 120 connects to network 100 and communicates with trusted entity server via network 100 using any of the methods well known in the art. Financial clearinghouse 120 contains a method and information for verifying the credit status of any of consumers 107 operating any of consumer devices 105 and debiting an account of any of consumers 107 in favor of trusted entity server 112 when any of consumers 107 engages in a purchase transaction. Financial clearinghouse 120 may be, for example, VISA, MasterCard, American Express and national or international banking clearing houses.

Alternatively, the functions performed by financial clearinghouse 120 may be included in trusted entity server 112. In this embodiment, trusted server entity 112 issues a credit line to each of consumers 107 that it deems creditworthy and debits that credit line when any one of consumer 107 engages in a purchase transaction using trusted entity server 112.

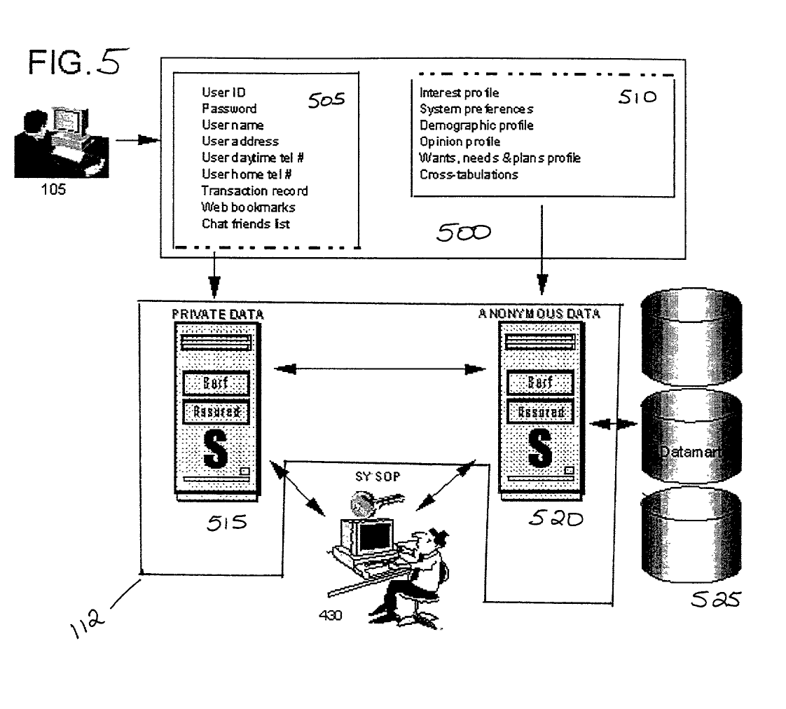

Referring now to FIG. 5, there is shown a block diagram of trusted entity server 112 and a consumer data record 500. An integral part of the present invention is the formation of a consumer data record 500 for each of consumers 107 that use trusted entity server 112. Consumer data record 500 includes two portions: a private data portion 505 and a demographic data portion 510.

When consumers 107 initially communicate with trusted entity server 112 via network 100, a registration process is initiated that includes the filling out of an initial questionnaire that is transmitted to each consumer 107 via network 100. The initial questionnaire collects information that is divided into two categories: private data that includes consumer contact information, and demographic data that includes information relating to consumer system preferences, interest profile, demographic profile, opinion profile and any other demographic information that is desirable. The initial questionnaire is sufficiently extensive to gather information with the level of detail necessary to carry out the features and functions that will be described below. For example, questions relating to consumer contact information may include the following questions:

### Contact Information

1) Name (First, Middle, Last)

2) Daytime Telephone Number:

3) Evening Telephone Number:

4) Postal Address:

5) Street Address:

6) City:

7) State or Province:

8) Zip or Postal Code:

9) Country:

10) E-mail Handle:

11) Password:

Examples of questions that may be included in the initial questionnaire that relate to demographic data are:

### Interest Profile

1) Hobbies include:

2) Are you interested in sports?:

3) Which sports do you follow (indicate the intensity of your interest on a scale of 1-10)?

4) Which sports do you actively participate in (indicate with number of hours per week, for recreation only, and which you are actively working to improve in (on a scale of 1-10)?

5) What is/are your favorite genre(s) of music (indicate the intensity of your interest on a scale of 1-10)?

6) Do you buy Compact Discs (number per year online/number per year mail order/number per year in retail store)?

7) Do you buy prerecorded cassette tapes (number per year)?

8) Do you buy music DVDs (number per year)?

9) Do you download music? If so, how many hours per month? What format?

10) Are you interested in purchasing new equipment for playing music? Please indicate below by type of device and how soon: [Music DVD/Portable CD Player/Home Theater Electronics/Stereo Speakers/Home Theater Speakers/Portable MPEG Player)?

### Demographic Profile

1) Age

2) Income

3) Tell us about your home. Do you live in: Owned House, Rented House, Condo, Cooperative, Owned Apartment, Rented Apartment, Live with parents, Live at college, Live with other relative, in a Mobile home or in Government Housing.

4) Tell us about your work. Is your job in: Consulting, Corporate Management/Owner, Development, Education, Engineering, Finance, Health Care, Legal, Management, Marketing, Media, MISS/IS, Networking/LAN, Purchasing, Research & Development, Sales, Student (pre-high school), Student(high school), Student (college),Student (postgraduate),Shipping/Receiving, Technical Support, Web/Internet.

### System Preferences

1) Simple text interface options

2) Simple text with icons options

3) E-mail window options

4) Chat window options

5) Reminder options

6) Web options

7) News options

8) Product/ad options

9) Wrangle options

In an exemplary embodiment, the initial questionnaire includes the questions listed in Appendix A.

After consumers 107 responds to the initial questionnaire, the responses are transmitted to trusted entity client 112 via network 100 and stored in consumer data record 500—the private data being stored in private data portion 505 and the demographic data being stored in demographic data portion 510.

In the embodiment shown in FIG. 5, trusted entity server 112 includes two servers: a private data server 515 in which private data portion 505 of consumer data record 500 is stored and an anonymous data server 520 which stores demographic data portion 510 of consumer data record 500. The purpose of dividing consumer data record 500 in such a manner and storing private data portion 505 on private data server 515 is to ensure that consumer contact information is kept confidential and secure. In addition, because the two halves of consumer data record 500—private data portion 505 and demographic data portion 510—are stored separately, no one other than an operator of trusted entity server 112 with proper authorization can unite the two halves to associate particular demographic data with its corresponding consumer. Thus, the demographic data stored in demographic data portion 510 is kept anonymous and the confidential information stored in private data portion is kept secure from unauthorized access.

After the registration process that includes consumers 107 filling out the initial questionnaire and constructing demographic data portion 510 for each of consumers 107, demographic portion 510 is further updated in a number of ways. First, trusted entity server 112 transmits to consumer devices 105 for each of consumers 107 via network 100 one or more subsequent questionnaires. The subsequent questionnaires may include the same questions included in the initial questionnaire, for the purpose of keeping the demographic data in demographic portion 510 current, or the subsequent questionnaires may include new questions not previously sent to consumers 107.

In addition, demographic data portion 510 is updated based on the activities of each of consumers 107. These activities include the interaction of consumers 107 with trusted entity server 112, such as the requests of consumers 107 for information or expressed desire to purchase a product or service, or any other services provided by trusted entity server 112, as will be described in detail below. So, for example, if consumer 107.1 has previously purchased white kitchen appliances, an entry is made in demographic data portion 510 of consumer 107.1 indicating that consumer 107.1 has a preference for the color white.

The activities used to update demographic data portion 510 may also include the interaction of consumers 107 with network 100. For example, if network 100 is the Internet, trusted entity server 112 will track the movements made by consumers 107 on the Internet and, where relevant, use this information to update demographic data portion 510 of each of consumers 107. For example, if one of consumers 107 accesses web pages relating to a white toaster oven and a white refrigerator, an entry is made in demographic data portion 510 of that one of consumers 107 indicating a preference for white kitchen appliances. An additional example is when one of consumers 107 accesses web pages relating to golf, golf equipment and golf schools indicating that one of consumers 107 may be investigating the cost of golf equipment and golf lessons. Based on this interest, trusted entity server 112 queries the one of consumers 107 about whether it would like to see information or advertising on golf equipment and golf schools.

Finally, each of consumers 107 can edit both private data portion 505 and demographic data portion 510 contained in their own consumer data record 500. So, for example, if consumer 107.1 wishes that certain activities over network 100 not be included in demographic data portion 510, consumer 107.1 can edit its demographic data portion 510 to delete references made to such activities. In this way, consumers 107 can control the contents of their own consumer data record 500.

Attached to anonymous server 520 is a datamart 525 used to store information used by anonymous server 520. Datamart 525, which may be any storage device including, but not limited to, a hard disk drive, holds demographic data portion 510 of consumer data record 500. In addition, datamart 525 stores other information that is used by trusted entity server 112, including for example, information relating to products or services that consumers 107 have previously requested.

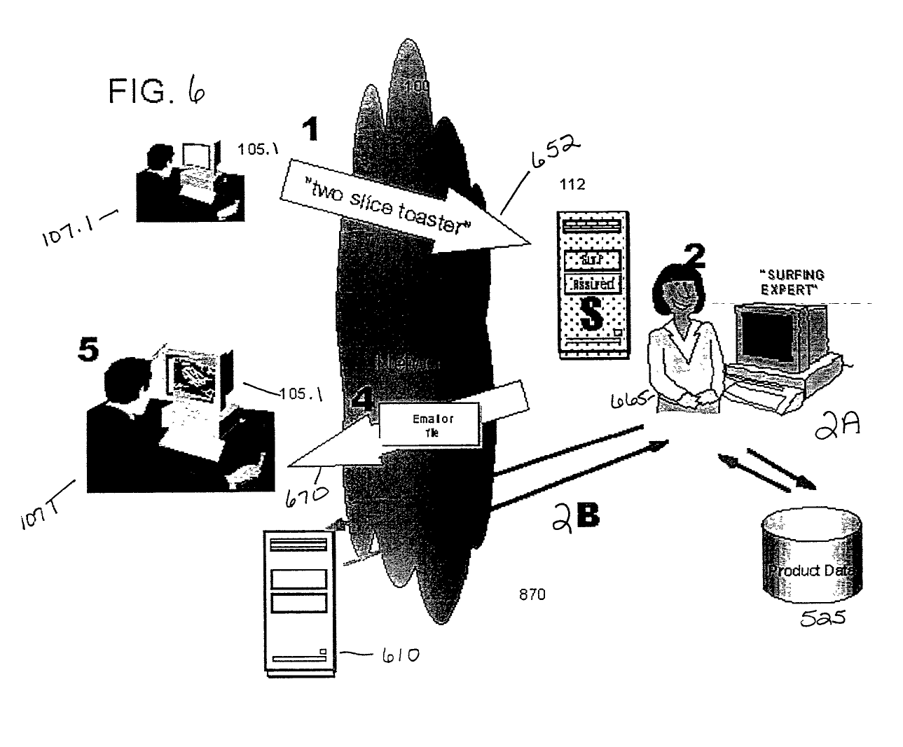

Referring now to FIG. 6, there is shown a block diagram describing the method by which a search request from one of consumers 107 is fulfilled in accordance with the present invention. In Step 1, consumer 107.1, for example, using consumer device 105.1, issues an information request 652, for information regarding two slice toaster ovens. Information request 652 is transmitted via network 100 and is received by trusted entity server 112. Next, in Step 2A, trusted entity server 112 searches datamart 525 for any information that matches the search request of consumer 107.1. In addition, in Step 2B, trusted entity server 112 forwards the search request to other servers 610 that are connected to network 100. The product information that trusted entity server 112 receives in response may include, but is not limited to, product descriptions, suppliers that offer the product, pricing, warranty information and product reviews.

After trusted entity server 112 receives product information from datamart 525 and other servers 610 relating to the information request of consumer 107.1, in Step 3 trusted entity server 112 filters the product information in a number of ways so that it is responsive to information request 652. First, the product information is filtered to remove any references to products other than two slice toaster ovens. For example, if the search of datamart 525 and other servers 610 returned references to four slice toaster ovens, these references are not included in the response to consumer 107.1. In one embodiment, this filtering step is performed manually by a “surfing expert” 665 that compares the product information received by trusted entity server 112 in response to information request 652 and removes any irrelevant information. Alternatively, trusted entity server 112 may execute an artificial intelligence program to perform this winnowing step. Such an artificial intelligence program may incorporate any of the techniques well known in the art that can used for evaluating and comparing textual information, including, by way of non-limiting example, neural networks, decision trees, genetic algorithms and nonlinear regression methods.

Trusted entity server 112 also filters the product information it receives in response to the information request using the demographic data contained in demographic data portion 510 of consumer data record 500 associated with consumer 107.1. For example, if the demographic data indicates that consumer 107.1 has a strong preference for white kitchen appliances, then trusted entity server 112 will only include in the response to the information request product information relating to white two slice toaster ovens. Thus, by using the demographic data contained in demographic data portion 510, trusted entity server 112 provides consumer 107.1 focused information in response to information request 652 of consumer 107.1. In addition, trusted entity server 112 customizes the response to information request 652 according to the system preferences selected by consumer 107.1 that are stored in customer data record 500. For example, consumer 107.1 may choose to have in the response the product specifications, pricing, warranty information names of suppliers, manufacturer's magazine style advertising, a streaming commercial for the product or any other type of information in any other format that is desirable. In an exemplary embodiment, the response to information request 652 does not include the names of suppliers of the product or service that was the subject of information request 652.

Finally, in Step 4, trusted entity server 112 sends a message 670 to consumer 107.1 containing a focused and tailored response to information request 652.

In an exemplary embodiment, information request 652 may request general information not relating to a product or service. For example, if consumer 107.1 requests information about Raynaud's Syndrome, message 670 sent by trusted entity server 112 to consumer 107.1 will contain only relevant information pertaining to Raynaud's Syndrome. In this way, consumer 107.1 does not have to waste time sifting through an enormous amount of irrelevant information to get information that is pertinent the topic of interest.

Accordingly, a method is provided in which a response to a search request from a particular consumer is provided that does not include non-responsive information, that is tailored to the interests of the particular consumer, as defined by the demographic data provided by the particular consumer and that is presented to the particular consumer in a preferred format.

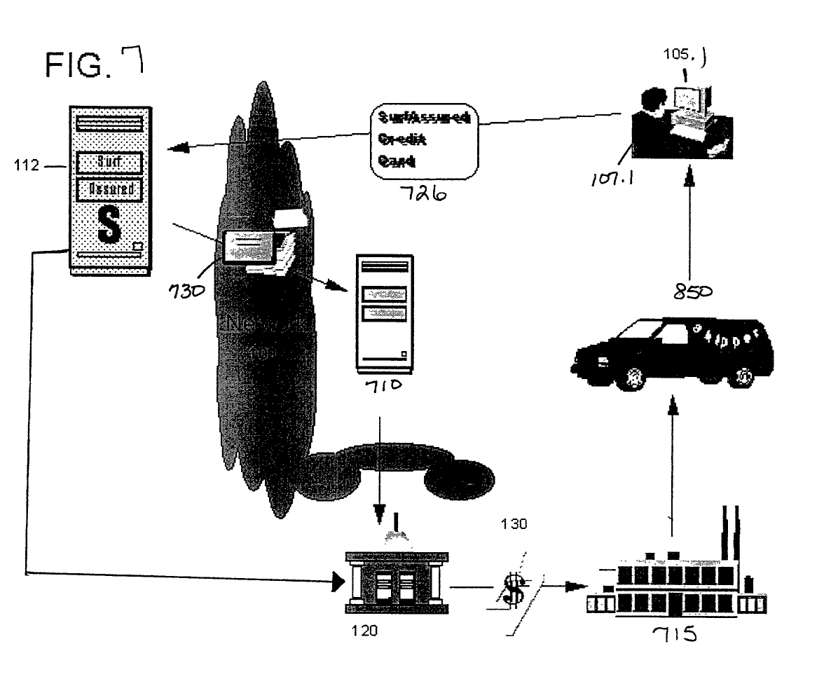

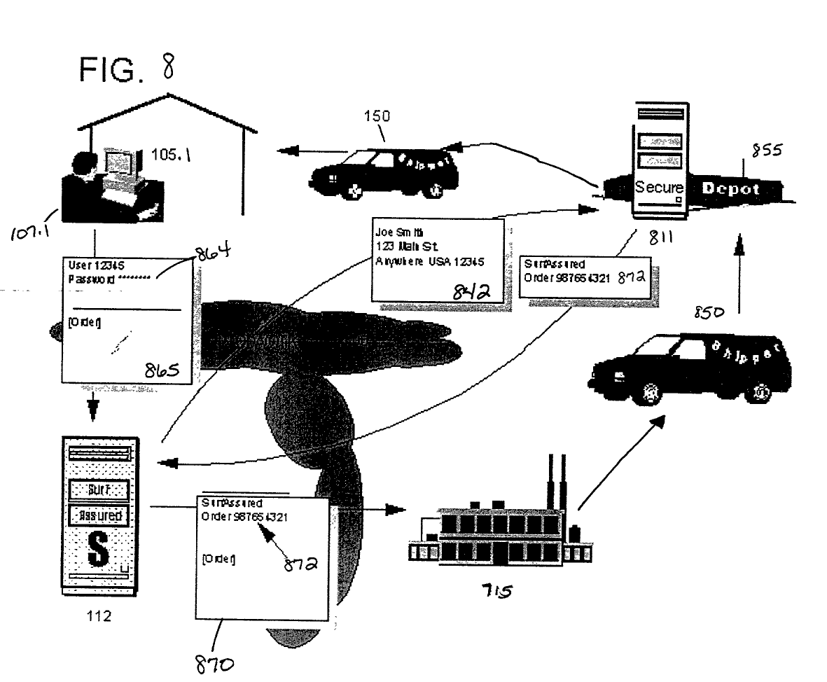

Referring now to FIGS. 7 and 8, there is shown block diagram of an e-commerce transaction conducted in accordance with the present invention and the flow of consumer identification information in the e-commerce transaction. Consumer 107.1 operating consumer device 105.1 initiates a transaction by issuing a purchase request 865 authorizing trusted entity server 112 to purchase a particular product or service for consumer 107.1.

Purchase request 565 can include a request for any product or service that consumer 107.1 desires. For example, consumer 107.1 can request the purchase of a two slice toaster oven that was the subject of a previous information request. Alternatively, consumer 107.1 may issue purchase request 865 to have a pizza delivered to the home of consumer 107.1 for dinner. Another example as to what may be included in purchase request 865 is a request from consumer 107.1 that a trusted associate pick up the children of consumer 107.1 from school and bring them home. Accordingly, purchase request 865 may include a request for any product or service desired by consumer 107.1.

For security purposes, purchase request 865 includes a consumer identification number and password combination 864 that uniquely identifies the consumer to trusted entity server 112. In addition, purchase request 865 may identify a particular supplier 715 from whom trusted entity server 112 should purchase and a particular price at which to purchase the product. Consumer 107.1 may have, for example, previously issued a product information request and the response to that request may have included supplier 715 that offers the product at a price that is acceptable to consumer 107.1. Alternatively, purchase request 865 does not direct trusted entity server 112 to purchase the desired product from a particular supplier. In such a case, trusted entity server 112 may either arbitrarily select a supplier, select a supplier based on the demographic data of consumer 107.1 or initiate a bidding process, as will be described below.

Trusted entity server 112 may select a supplier from a list of suppliers based on the particular needs and buying habits of consumer 107.1 as expressed in the demographic data of consumer 107.1. For example, if the demographic data of consumer 107.1 indicates that consumer 107.1 has previously purchased toaster ovens that broke prematurely, trusted entity server 112 may select a supplier that offers the best warranty service on their taster ovens. In this way, consumer 107.1 will be purchasing the toaster oven from a supplier that best fits its needs.

Furthermore, the process of selecting a supplier based on the demographic data of consumer 107.1 also provides a strong incentive for suppliers to provide their product information and pricing to trusted entity server 112 and keep such information current. Because trusted entity server 112 looks for a supplier that can best fulfill the needs of consumer 107.1, suppliers that interact with trusted entity server 112 sell their products and services to consumers that are within their target market, are pre-qualified by trusted entity server 112 and which the suppliers can best service. As a result, suppliers benefit greatly by interacting with trusted entity server 112.

Upon receiving purchase request 865 from consumer 107.1, trusted entity server 112 first clears the purchase by determining whether consumer 107.1 has sufficient credit in a credit line 726 belonging to consumer 107.1 to cover the purchase price of the desired product and, if sufficient purchasing power exists, debits credit line 726 in favor of an account of trusted entity server 112. In an exemplary embodiment, the clearing process includes trusted entity server 112 communicating with financial clearinghouse 120 which verifies credit line 726 of consumer 107.1 and also transfers funds, in the amount of the purchase price of the product, from credit line 726 to the account of trusted entity server 112. In an alternative embodiment, consumer 107.1 purchases products using credit line 726 provided to consumer 107.1 by trusted entity server 112. In this case, the step of clearing the purchase of consumer 107.1 amounts to trusted entity server 112 determining whether consumer 107.1 has sufficient credit remaining in credit line 726 to cover the purchase price of the desired product.

Once the purchase is cleared, trusted entity server 112 communicates through network 100 with a supplier server 710 that is used by supplier 715 to conduct transactions over network 100. Trusted entity server 112 transmits to supplier server 710 a purchase order 870 that includes an order number 872 and the product or service that is the subject of purchase request 865. Purchase order 870, however, does not contain any confidential consumer information that could be used by supplier 715 to identify consumer 107.1. Furthermore, supplier 715 does not have access to the confidential consumer information stored on trusted entity server 112, or in the embodiment of FIG. 5, stored on private data server 515.

To complete the transaction with supplier 715, trusted entity server 112 provides supplier server 710 with a credit line 730 associated with trusted entity server 112 against which supplier 715 will charge the purchase price of the product or service. By using credit line 730 instead of credit line 726 of consumer 107.1 to purchase from supplier 715, the identity and financial information of consumer 107.1 is not disclosed to supplier 715. Thus, trusted entity server 112 acts as complete buffer between consumer 107.1 and supplier 715 thereby keeping the identity and financial information of consumer 107.1 confidential.

After supplier server 710 debits credit line 730 of trusted entity server 112 through financial clearinghouse 120, supplier 715 ships the product via shipping entity 850 to a transhipping depot 855 and identifies the product with order number 872 included in purchase order 870. Once the product is received by transhipping depot 855, transhipping depot 855 uses a secure server 811 to transmit, over network 100, order number 872 to trusted entity server 112. In response, trusted entity server 112 sends to secure server 811 consumer shipping information 842 that corresponds to order number 872. Using consumer shipping information 842, transshipping depot 855 ships the product to consumer 107.1.

Transhipping depot 855 may be either affiliated or unaffiliated with trusted entity server 112 as long as transhipping depot 855 is a secure facility that can receive shipments from multiple suppliers, retrieve confidential consumer information 842 from trusted entity server 112 and ship the product to consumer 107.1.

Accordingly, an e-commerce method is provided in which trusted entity server 112 acts as an intermediary between consumer 107.1 and supplier 715 thereby eliminating the need for consumer 107.1 to divulge any personal or financial information to supplier 715. As a result, consumer 107.1 is provided with a secure and discreet online shopping environment.

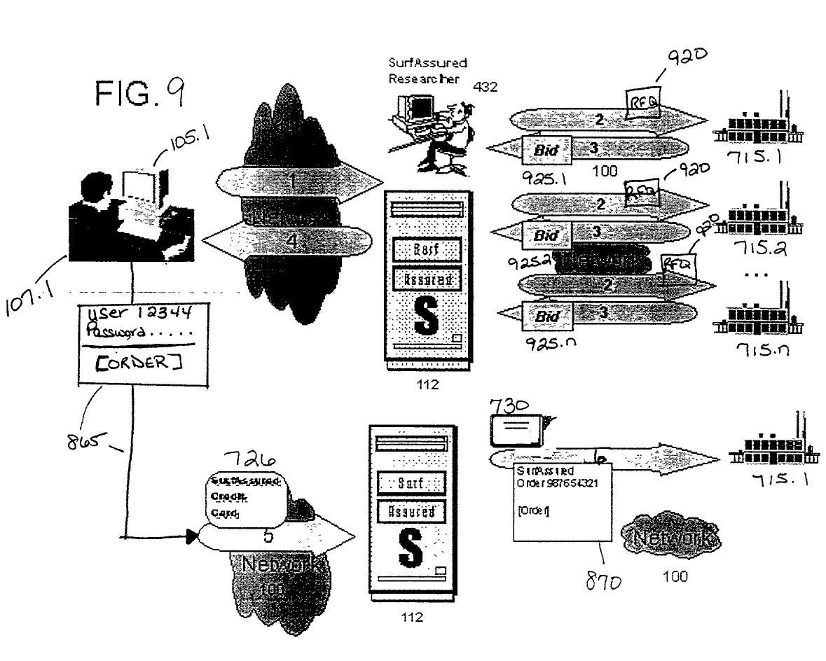

Referring now to FIG. 9, there is shown a method by which a supplier for the product or service requested by consumer 107.1 is determined using a bidding process. In Step 1, consumer 107.1 contacts trusted server entity 112 through network 100 to express interest in a product or service. Consumer 107.1 may indicate interest in a product to trusted entity server 112 either at the time consumer 107.1 fills out the initial questionnaire or updates consumer data record 500 or by directly asking trusted entity server 112 for information about the product or service or to find supplier 715 offering the best deal on the particular product or service.

In Step 2, trusted entity server 112 sends to a plurality of suppliers 715.1-715.n, via network 100, a request for quotation (RFQ) 920 for the desired product or service. Trusted entity server 112 chooses suppliers 715.1-715.n either by examining the suppliers stored in datamart 525, by using a research specialist 432 that searches for suitable suppliers or by using shopping agent technology, known in the art, that automatically identifies suppliers for a given product category. In this step, trusted entity server 112 does not reveal the identity of consumer 107.1 to suppliers 715.1-715.n.

In Step 3, each of suppliers 715.1-715.n returns a bid 925.1-925.n, respectively, for the product or service in response to RFQ 920. Then, trusted entity 112 compares bids 925.1-925.n to determine which are the best. To determine which of bids 925.1-925.n are the best, trusted entity server 112 may look at variety of factors including, but not limited to, price, quality, warranty and delivery time. Also, trusted entity server 112 may use the demographic data of consumer 107.1 stored in demographic data portion 510 to determine if consumer 107.1 is likely to have any preferences for one of bids 925.1-925.n. For example, if the demographic data indicates that consumer 107.1 prefers white kitchen appliances, the one of bids 925.1-925.n that includes a white two slice toaster oven would be preferred over those that offer black two slice toaster ovens. Based on the above factors or any other suitable factors, trusted entity server 112 determines which bids 925.1-925.n are the best.

Next, in Step 4, trusted entity server 112 sends to consumer 107.1 the best of bids 925.1-925.n received for the product consumer 107.1 desires to purchase. Trusted entity server 112 sends this information to consumer 107.1 in the format preferred by consumer 107.1, as indicated in consumer data record 500. Such formats may include, by way of non-limiting example, text based e-mail, banner ad, fixed photo and text e-mail, or streaming video ad.

Next, in Step 5, consumer 107.1 selects a particular bid, for example, bid 925.1 offered by supplier 715.1, and initiates an e-commerce transaction by sending trusted entity server 112 purchase request 865 and credit line 726. Finally, in Step 6 the e-commerce transaction is then consummated by trusted entity server 112 by sending purchase order 870 to supplier 715.1 as described above in reference to FIGS. 7 and 8.

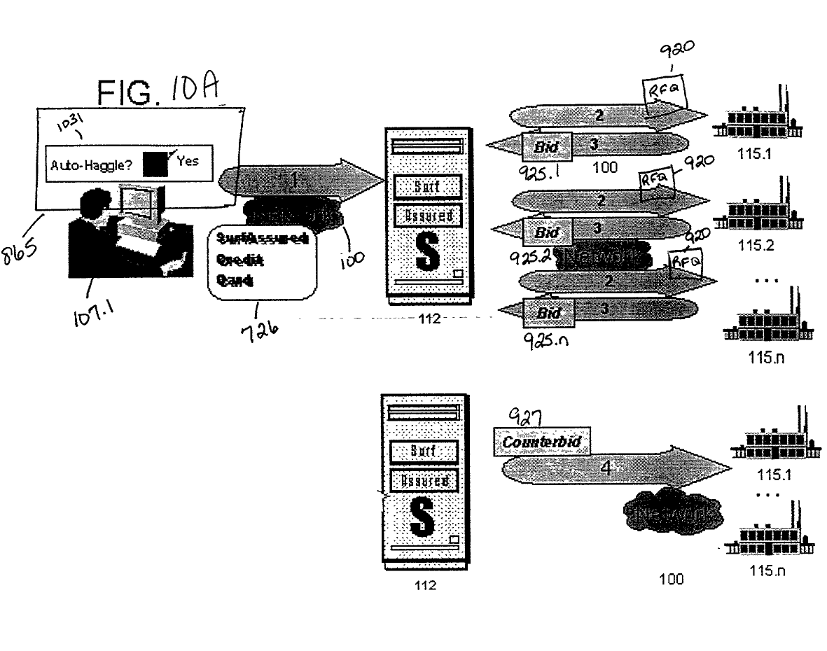

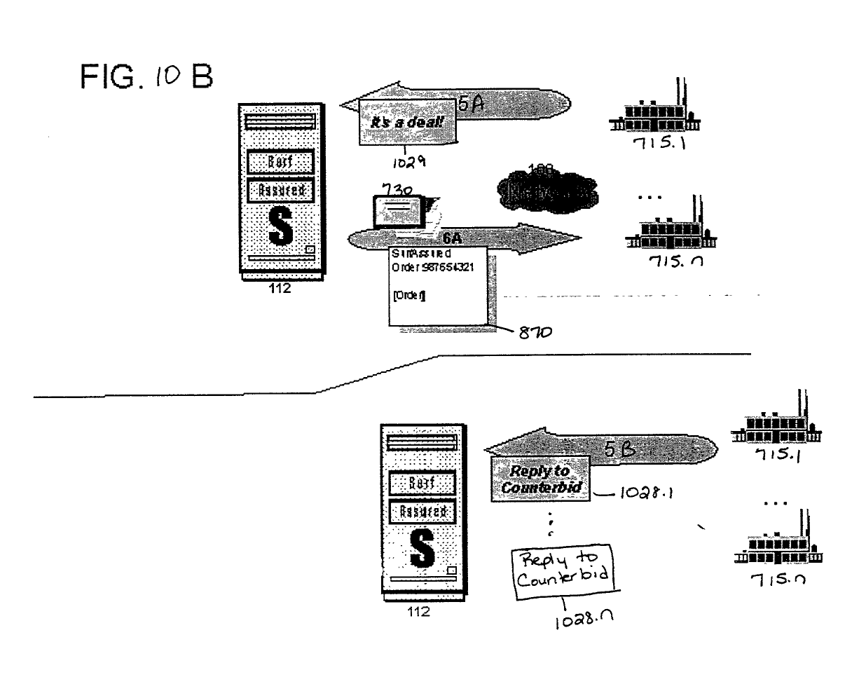

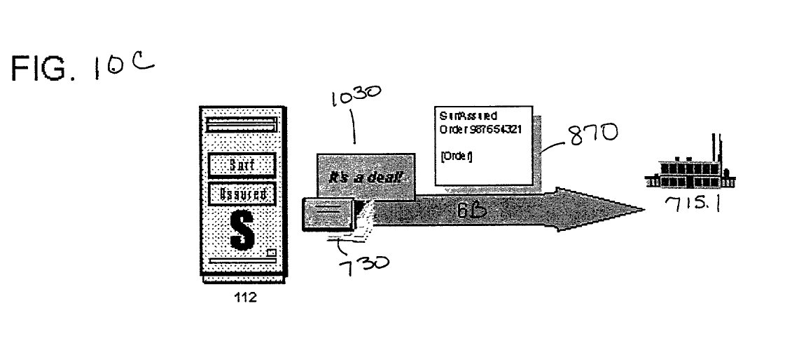

Referring now to FIGS. 10A-10C, there is a shown a method by which trusted entity server 112 negotiates with suppliers 715.1-715.n to get the best deal for consumer 107.1. In this embodiment, the transaction begins at Step 1 in the same manner as in the method described in FIG. 9 except that in the method of FIGS. 10A-10C consumer 107.1 selects an “auto-wrangle” feature 1031 when sending purchase request 865 to trusted entity server 112. Upon receipt of purchase request 865, trusted entity server 112 in Step 2 sends to suppliers 715.1-715.n, via network 100, RFQ 920 for the desired product or service. In Step 3, each of suppliers 715.1-715.n returns bid 925.1-925.n, respectively, for the product or service in response to RFQ 920 and trusted entity 112 compares bids 925.1-925.n to determine which are the best. Next, in Step 4, trusted entity server 112 “wrangles” with those of suppliers 715.1-715.n having the best bid(s) by issuing a counterbid 927 to those of suppliers 715.1-715.n.

Trusted entity server 112 determines what is appropriate to include in counterbid 927 using any number of techniques. First, trusted entity server 112 can simply request a discount from those of suppliers 715.1-715.n by including in counterbid 927 a desired price for the product or service that is some percentage less than what was previously offered by those of suppliers 715.1-715.n in bids 925.1-925.n, respectively. Alternatively, counterbid 927 may request a better deal from those of supplier 715.1-715.n with respect to any other characteristic of previous bids 925.1-925.n such as warranty, delivery or quality. Also, trusted entity server 112 may use the demographic data contained in demographic data portion 510 to formulate counterbid 927. For example, if the demographic data indicates that consumer 107.1 favors kitchen appliances from brand X and the best bid is for a two slice toaster oven from brand Y, trusted entity server 112 may counterbid supplier 715 requesting a better price for the two slice toaster oven from brand Y.

Next, in Step 5A, if counterbid 927 is accepted by one of those suppliers 715.1-715.n, for example, by 715.1, then supplier 715.1 sends a confirmation notice 1029 indicating that a deal has been reached. Then, in Step 6A, trusted entity server 112 sends purchase order 870 to supplier 715.1 thereby purchasing the product on behalf of consumer 107.1. If, however, counterbid 927 was not accepted by any of suppliers 715.1-715.n, then in Step 5B one or more of suppliers 715.1-715.n may send a reply to counterbid 1028. If reply to counterbid 1028, for example issued by supplier 715.1, is acceptable to trusted entity server 112, then in Step 6B trusted entity server sends a confirmation 1030 to supplier 715.1. If reply to counterbid 1028 is not acceptable to trusted entity server 112, the “wrangling” process returns to Step 4 in which trusted entity server 112 issues another counterbid 927. The wrangling process continues in this manner until either one of suppliers 715.1-715.n offers the product or service at an acceptable discount price or until no discount price is offered by any one of suppliers 715.1-715.n, in which case trusted entity server 112 will purchase the product or service at the originally offered price (the price at which the consumer originally authorized the purchase in purchase request 865).

If trusted entity server 112 was successful in purchasing the desired product or service from one of suppliers 715.1-715.n at a price that is below the initial price offered by that one of suppliers 715.1-715.n, then trusted entity server 112 will store in datamart 525 a notice to the effect that that one of suppliers 715.1-715.n is amenable to negotiations and discounting its initially offered price. In this way, trusted entity server 112 builds a file of suppliers that are willing to negotiate the price of the products they offer.

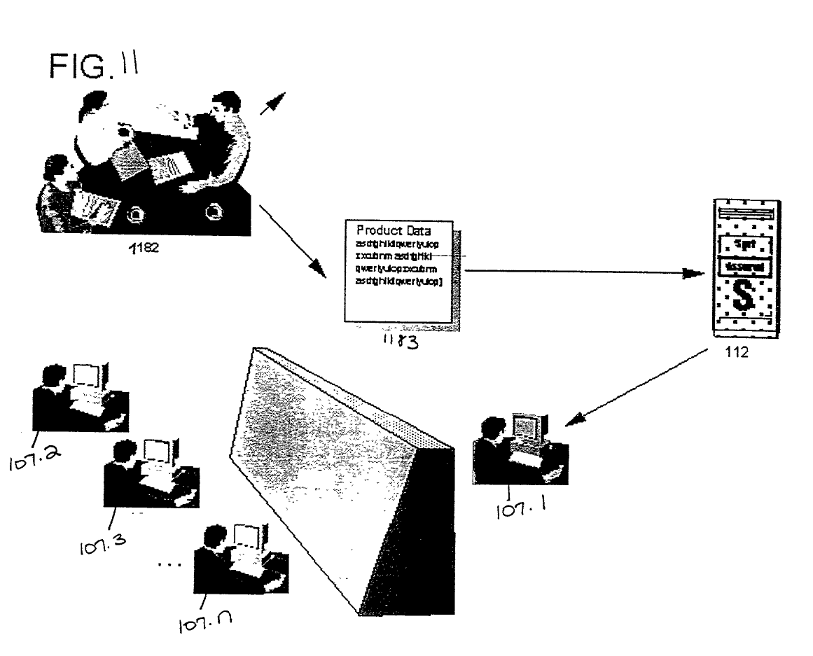

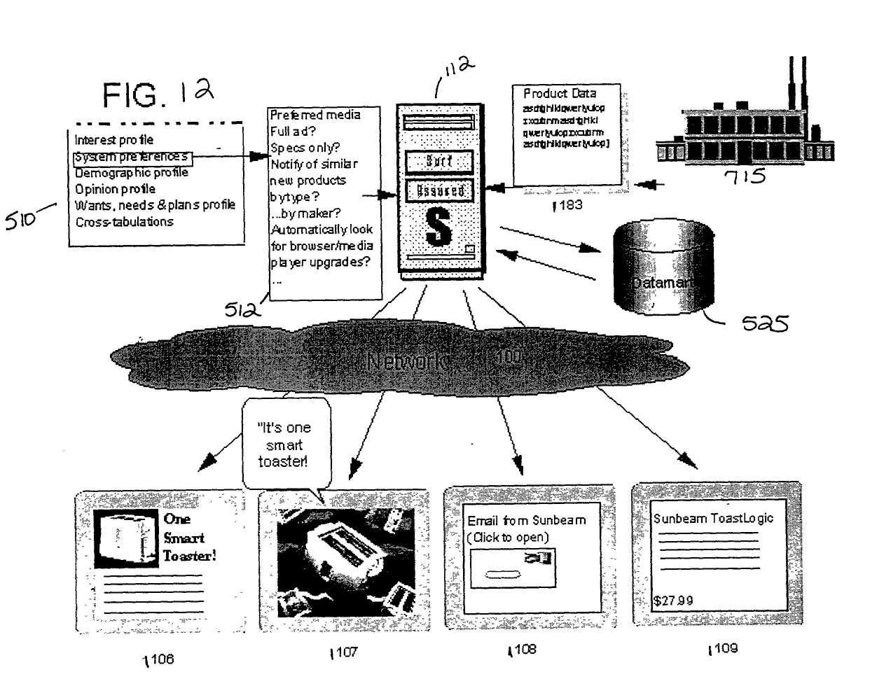

Referring now to FIGS. 11 and 12, there is shown a block diagram of a method of providing targeted advertising in accordance with the present invention and the flow of information between an advertising entity 1182 and consumers 107.1-107.n. Initially, advertising entity 1182 provides trusted entity server 112 with advertising materials 1183 which may include a product description, pricing information, warranty information, a magazine style advertisement and/or a streaming commercial for a product or service. Advertising materials 1183 are stored by trusted entity server 112 in datamart 525. When, for example, consumer 107.1 expresses an interest in a product or service, trusted entity server 112 scans advertising materials 1183 in datamart 525 for relevant information. Trusted entity server 112 may determine that consumer 107.1 is interested in a particular product or service if consumer 107.1 requested information about the product or service, requested that trusted entity server 112 purchase the product or service for consumer 107.1, or if consumer data record 500 associated with consumer 107.1 contains an indication that consumer 107.1 is interested in the product or service. Once trusted entity server 112 identifies the information in advertising materials 1183 that is relevant to the request or interest of consumer 107.1, trusted entity server 112 then transmits the relevant materials to consumer 107.1. In this way, advertising materials 1183 are sent to those consumers who have expressed an interest in the product that is the subject matter of the particular advertising material 1183. On the other hand, trusted entity server 112 will not send the particular advertising material 1183 to consumers 107.2-107.n that either did not request information about, or otherwise express interest in, the product that is the subject of the particular advertising materials 1183.

Accordingly, advertising entities 1182 are given a method of reaching a focused and targeted consumer audience that has expressed an interest in a particular product or service. Also, because the consumer will not receive any advertising materials unless the consumer has expressed interest in a related product or service, the incidence of consumers receiving SPAM in the present invention is eliminated.

Trusted entity server 112 sends relevant advertising material 1183 to consumer 107.1 according to the preferences indicated by consumer 107.1 and stored in a system preferences record 512 of consumer data record 500. For instance, consumer 107.1 may select to see a full advertisement for the product of interest, only the product specifications, manufactures of the product, suppliers of the product, pricing information and whether to be notified of similar new products. In addition, consumer 107.1 may choose whether to see advertising materials 1183 as a flat data file 1106, as a streaming commercial with sound 1107, as an e-mail message 1108 or as a magazine style ad 1109. Besides the examples given above, consumer 107.1 may be given a choice to view any other type of information and in any other desired format. Accordingly, advertising materials 1083 are sent by trusted entity server 112 only to those consumers that have expressed interest in the advertised product and in a format that is most desirable to the consumer.

In an exemplary embodiment, the demographic data stored in demographic data portion 510 of consumer data record 500 is used to perform market surveys. So, for example, if a manufacturer would like to know what is the most popular color for two slice toaster ovens, the manufacturer submits the survey request to trusted entity server 112. Trusted entity server 112 then scans datamart 525 for consumer preferences regarding the color of two slice toaster ovens and reports back to the manufacturer which color is the most popular.

The present invention can also be used to perform highly targeted focus group testing. In this embodiment, a manufacturer, for example, wants to determine what features on a two slice toaster oven are favored by men ages 25-40. The manufacturer sends the survey request to trusted entity server 112 together with a series of questions aimed at determining which are the most favored features. Trusted entity server 112 receives the survey request and scans the consumer data records for demographic data that matches the target market selected by the manufacturer—in this case men ages 25-40. Trusted entity server 112 then sends to those consumers in the target market a subsequent questionnaire that includes the series of questions provided by the manufacturer. Trusted entity server 112 receives the responses to the subsequent questionnaire and forwards the results to the manufacturer. The result is that the manufacturer receives responses to its survey questions from the specific target market it seeks to satisfy.

In addition, the present invention can be used to provide “life management” functions to consumer 107.1. Because the demographic data collected by trusted entity server 112 includes details such as the wedding anniversary of consumer 107.1 ,what medication consumer 107.1 takes, which stocks consumer 107.1 owns or the value of life insurance owned by consumer 107.1, trusted entity server can make suggestions to consumer 107.1 based on the consumer's demographic data. For example, if the wedding anniversary of consumer 107.1 is coming up and trusted entity server 112 gleans from the demographic data of consumer 107.1 that consumer 107.1 likes to give jewelry as an anniversary present costing in the range of $200, trusted entity server 112 will present consumer 107.1 with a selection of gifts that meet this criteria at an early enough date so that consumer 107.1 can select a particular gift, have it purchased by trusted entity server 112, as described above, and receive delivery in time for the anniversary.

Thus, according to the present invention a method a system is provided enabling a consumer to find focused information regarding a product the consumer desires to purchase and a suitable supplier from which to purchase the product. Also, a method is provided in which a consumer desiring to purchase a product from a supplier does not have to divulge personal and financial information to the supplier in order to consummate the transaction. In this way, the consumer's personal and financial information is kept confidential. Also, the present invention provides a method by which suppliers can advertise a product to customers that have expressed interest in the product while at the same time not intruding on the privacy of those consumers that did not express interest in the product.

It will thus be seen that the embodiments set forth above, among those made apparent from the preceding description, are efficiently attained and, because certain changes may be made in carrying out the above method and in the construction set forth without departing from the spirit and scope of the invention, it is intended that all matter contained in the above description shall be interpreted as illustrative and not in a limiting sense.

### Appendix-A

SurfAssured Questionnaire

Copyright© 1999, Underwriters Digital Research Inc

First Name:

Middle Initial:

Last Name:

Mailing Address (Street/PO Box)

Mailing Address (Street/PO Box, line 2)

City

State

Zip or Postal Code

Country

Residential Address (Street/PO Box)

Residential Address (Street/PO Box, line 2)

City

State

Zip or Postal Code

Country

Date of birth:

Home telephone number:

Work or other daytime telephone number

Choose Your Member Name

Choose a Password (6 to 10 characters):

Retype Password:

Credit Card Type

Credit Card Number

Expiration

ABOUT YOU AND YOUR FAMILY

Your date of birth:

Your place of birth:

Your gender:

Your marital status:

Name of spouse:

Spouse's birthday:

Your wedding date:

How many times have you been previously married?

Do you have any children?

How many?

List their names and birthdates:

Number of Children:

What is your ethnic heritage?

What is your sexual orientation?

Are you paying any outside alimony and/or child support?

Were you raised by both parents, one parent and/or stepparents?

Enter your parents'names and birthdates:

Enter any step-parents' names and birthdates:

Are your parents still living?

If so, what are their ages?

When are your parent's birthdays/date(s) of birth?

Would you like to be reminded of birthdays and/or anniversaries in advance?

Would you like to order birthday, anniversary, Valentine's, Mother's and/or Father's Day cards, flowers and/or gifts in advance?

Did you attend college?

Do you or have you ever served in the military or reserves?

Do you or would you encourage your children to attend college?

Do you or would you encourage your children to pursue a military career?

How much do you think it will cost to send each child through four years of college at a private university by the time they graduate from high school?

How about the cost of a state university in your home state?

Have you begun to make plans for financing your or your children's education?

YOUR HOME

Enter the type of home which is your permanent residence:

Do you rent or own this home?

What are your monthly rental, mortgage, and/or maintenance costs?

What would you estimate the value of your home is today?

Do you own a second home or any other residential property?

What type:

Do you own any undeveloped land?

Do you plan to develop or build on this land at any time in the future?

Would you consider selling this land?

Are you considering additions or improvements to your current home?

If so, what type(s)? How soon do you plan to begin the improvement(s)?

Does your home have any of the following:

Garden or gardens

Outdoor cooking appliances

Swimming pool (what type)

Swing set/other play equipment for children

Do you pay anyone to maintain your property?

Please indicate your monthly outlay for maintenance:

Landscaping/gardening (seasonal)

Lawn mowing

Cleaning/maid service

Have you had any unexpected outlays for property repair in the last three years?

If so, for which of the following:

Plumbing

Septic service

Storm drain repair

Electrical system/wiring

Heating system/furnace repair

Structural repairs

Flooding

Storm damage

Do you own income property or rent living space in any of your properties?

How many rental units do you own?

What is the ANNUAL rent you charge on the unit(s)?

Which of the following appliances do you own:

Clothes washer

Clothes dryer

Small refrigerator

Medium capacity refrigerator

Large refrigerator

Freezer

Dishwasher

Cuisinart or other food processor

Espresso/cappuccino maker

Coffeemaker

Coffee grinder

Toaster

Toaster oven

Microwave oven

Convection oven

Bread maker

Waffle iron

Electric grill

Hot plate

In-sink disposal unit

Electric can opener

Electric mixer

When you decorated your home, did you hire a decorator or do it yourself?

Would you hire a decorator if you could afford it?

Are you planning on replacing or buying new furniture in the next year?

How about rent or mortgage payments—are they too high or just right for your income?

Do you consider your home a forced savings account?

How many percent do you think your home appreciates every ten years?

YOUR UTILITIES

Please check each of the following utilities that you pay for, with the amount you pay per month.

Electricity

Gas

Cable Television

Telephone

Satellite TV

Heating Oil

Is there competition in your community among local telephone providers?

Would you consider switching your phone service provider if an alternative provider would prove more cost-effective?

Who provides your long distance service?

Would you consider switching your long distance service provider if an alternative provider would prove

more cost-effective?

Do you own a cellular phone? Carrier: Cellular telephone number:

Do you own a pager? Pager number:

Is it text capable?

Is it capable of reading web pages? Internet chat?

Is there competition in your community among electrical providers?

Would you consider switching your electrical provider if an alternative provider would prove more cost-effective?

Is there competition in your community among cable TV providers?

Would you consider switching your television programming provider if an alternative provider would prove more cost-effective?

Does your cable TV provider also provide internet access?

Has your cable TV provider announced forthcoming internet access?

Would you consider switching the type of home heating you use were an alternative to prove more cost-effective?

YOUR WORK AND INCOME

What is your current household income before taxes?

Which category best describes your current primary occupation?

Do you work full-time or part-time?

How many hours per week?

What is the name of your current employer [or business]?

What is your income from this job?

Do you think you have been promoted properly at work?

How many raises have you received since you began working at your present job?

In all honesty—would you say you are overpaid, underpaid or paid just about right for what you do?

Do you hold a second job?

Which category best describes your secondary occupation?

How many hours per week?

What is the name of your secondary employer?

What is your income from this job?

Do you use a computer at your current job?

What percentage of your working time is spent on the computer?

What type of computer(s) do you use at work?

How long have you worked at your current occupation?

Which category best describes your previous primary occupation?

What was your income from that job?

(Students) In what area do you plan to work upon completion of your education?

(All) Are you considering the possibility of study at some future time?

Have you ever changed careers?

Have you ever considered a career change?

Are you considering a career change at this time?

Are you considering returning to school?

Would you consider an “Internet” university as a study alternative to traditional schools, colleges or specialized study courses?

Do you currently have an updated resume?

(Married) Does your spouse work?

Which category best describes his/her current primary occupation?

Does he/she work full-time or part-time?

How many hours per week?

What is the name of his/her current employer [or business]?

What is his/her income from this job?

Do you have other sources of income?

Please indicate each, and the amount per year your family earns:

Do any of your children currently living with you work?

Do they contribute to your household expenses?

Do you collect disability payments from either the government or another source? How much per month?

Do you or your spouse collect alimony from a previous marriage? How much per month?

YOUR TRANSPORTATION

How many vehicles do you or your family own?

Your primary vehicle: (make, model, year)

Tell us how your vehicle is equipped

Air conditioning

Radio

Stereo

Video

Phone

GPS

CB Radio

Scanner

Radar detector

OnStar or other emergency communication

Your other vehicles are (indicate by quantity):

Do you hold a driver's license?

If so, what state? What number? What is the expiration date?

Do you want to be reminded to renew your driver's license?

Do you own “vanity plates” for any of your vehicles? If so, which ones?

Please indicate the registration, serial and license plate number, and last inspection date for each of your vehicles:

Do you want to be reminded that your vehicle or vehicles require inspection?

How do you get to and from work?

Drive my car

Bus

Rail

Ferry

Use private transportation (cab/car service/private van or bus)

Bicycle

Walk

Combination of drive and public transportation

Is public transportation available in your community?

How would you characterize it?

Are you considering the purchase of a vehicle?

What type of vehicle? (compact car, full-size car, sports car, SUV, minivan, van, pickup truck)

What features will you want in your next vehicle? (Convertible, Air conditioning, Radio, Stereo, Video, GPS, CB Radio, Scanner, Radar detector, computerized directions, cell phone, OnStar or other emergency communication)

For personal or family use?

Do you have a passport?

If so, which is the number and when does it expire?

Do you wish to be reminded that you must renew your passport?

Do you own a boat?

What type?

Do you have a motor home?

How about a motorcycle?

Have you ever driven a motorcycle?

How about a jet ski or other personal watercraft?

Have you ever driven a jet ski or similar vehicle?

What is the one car you wish you could own?

Have you ever been injured in a car accident? If so, how and when?

Bow much do you think your primary vehicle is presently worth?

Your second car? Your third car?

EMERGENCIES

What is the telephone number of the Police in your home town (not 911)?

Ambulance?

Fire Department?

Closest friendly neighbor?

Does your neighbor have keys to your house?

Is your house alarmed?

Do you carry the name and number of your alarm company in your wallet at all times?

Which relative or relatives should be informed in the event of an emergency? (Name, day telephone, night telephone)

YOUR COMPUTER

Which brand of PC do you primarily use at home?

How many hours per week do you use it?

How often do you experience crashes, freezes, or other system failures?

Which of the following is your computer equipped with?

3D graphics card

Audio card

Professional video card

Professional audio card

64M or more of RAM

Less than 1 GB hard drive

1-2.99 GB hard drive

3-5.99 GB hard drive

6-8.99 GB hard drive

9 GB or greater hard drive

Zip drive

Jaz drive

Superdisk drive

Floppy disk drive

CD-ROM drive

CD-R writer

Tape backup

Inkjet printer

Laser printer

Professional quality printer

What software have you purchased for your computer that did not come preloaded?

Utilities/antivirus

Word processing

Spreadsheet

Database

Personal finance

Graphics/photo

Games

Music/multimedia

Personal organizer

Communications/Internet phone

Language recognition

Reference/encyclopedia/how-to

School-age educational

What non-business-related uses other than the Internet do you use your computer for? Check off each, with the average number of hours for each:

Games

Word processing

Personal finances

Organizing information/database management

Music/MP3/midi

Art/graphics/photos

Do you own any other computers?

Indicate which type and how many of each.

Do you plan on upgrading or replacing your computer in the next year?

If so, what brand or brands are you considering?

YOUR FINANCES—SAVINGS AND BANKING

Please provide information on your family's current banking accounts:

SAVINGS Bank: Account number: How long has this account been open?

SAVINGS 2 Bank: Account number: How long has this account been open?

CHECKING Bank: Account number: How long has this account been open?

CHECKING 2 Bank: Account number: How long has this account been open?

Do you have overdraft protection? How much? How long have you had this account?

How much of your income (not including contributions to retirement plans) do you save for the long term

every month?

How much would you like to save?

Would you consider switching to another bank if the service charges were lower?

Have you ever managed your bank accounts using a home computer, computer at your place of business or the World Wide Web?

Has your bank increased it fees in the last two years?

Has your bank merged with another bank in the last five years?

Does your bank charge you ATM fees to use its own machines?

YOUR FINANCES—RETIREMENT

Do you have an IRA, Roth IRA, 401 (k), or other retirement plan?

Please provide information on each—Carrier: Plan Number: Account Number:

Do you have an idea of what your social security benefits will be when you retire?

Do you plan to keep your home when you retire?

Are you enrolled in a pension plan or plans?

Please provide information on each of them—Carrier: Plan Number: Account Number:

Do you own any annuities?

Please provide information on each of them—Carrier: Plan Number: Account Number:

YOUR FINANCES—SECURITIES

Do you own stocks?

What is the value of your stock holdings in dollars?

Do you own bonds?

What is the value of your bond holdings in dollars?

Do you plan to retire on the proceeds of stock sales?

With whom do you have brokerage accounts (include retirement accounts)? Company: Approx. value of account: How long has this account been open?

Have you ever used an online brokerage service?

Would you be interested in learning about brokerage services?

YOUR FINANCES—CREDIT

Please list all of your credit card accounts

Bank: Account number: Current outstanding balance: Minimum monthly payment: Interest rate: Cash advance interest rate (if different): How long has this account been open?

Bank: Account number: Current outstanding balance: Minimum monthly payment: Interest rate: Cash advance interest rate (if different): How long has this account been open?

Bank: Account number: Current outstanding balance: Minimum monthly payment: Interest rate: Cash advance interest rate (if different): How long has this account been open?

Bank: Account number: Current outstanding balance: Minimum monthly payment: Interest rate: Cash advance interest rate (if different): How long has this account been open?

Bank: Account number: Current outstanding balance: Minimum monthly payment: Interest rate: Cash advance interest rate (if different): How long has this account been open?

Would you be interested in having your credit card bills paid automatically from your checking account?

Please list all of your other outstanding loans or lines of credit:

Type (mortgage, student loan, business loan) Bank: Account number: Current outstanding balance:

Minimum monthly payment: Interest rate:

Have you ever been sued for a bad debt?

Do you worry about having too much credit card debt?

YOUR FINANCES—INSURANCE

Do you have life insurance?

If so, what type?

With which carrier?

Who is the primary account holder?

How much are you insured for?

Your wife?

Your children?

Does your policy include other casualty benefits (i.e. loss of limb, etc.)?

What is your annual contribution?

Do you have a burial policy?

Do you think your life insurance will cover your estate taxes and leave enough left over to support your family?

How do you pay?

Do you have property insurance?

If so, what type?

With which carrier?

Who is the primary account holder?

What is your annual contribution?

How do you pay?

What is the annual deductible?

Do you have automobile insurance?

If so, what type?

With which carrier?

Who is the primary account holder?

What is your annual cost?

How do you pay?

What is the annual deductible?

Do you have any liability insurance?

If so, what type?

With which carrier?

Who is the primary account holder?

What is your annual cost?

How do you pay?

What is the annual deductible?

Would you consider switching to a different insurance carrier or carriers if better coverage at the same or lower cost were available?

YOUR HEALTH

What is the name, address, and telephone number of your primary physician or family practitioner?

What is the name, address, and telephone number of your dentist?

Are you enrolled in an HMO?

Do you have health insurance?

If so, what type?

With which carrier?

Who is the primary account holder?

What is your annual contribution?

How do you pay?

What is the annual deductible?

Do you have dental insurance?

If so, what type?

With which carrier?

Who is the primary account holder?

What is your annual contribution?

How do you pay?

What is the annual deductible?

How's your overall health?

Do you get a checkup regularly?

Do you think medicine is heading in the right or the wrong direction?

Would you rather have medical savings account or an HMO?

Have you ever had a major disease?

Have you ever had cancer?

Have you had a heart attack?

Stroke?

Diabetes?

Tuberculosis?

Leukemia?

Pollen or mold allergies?

Allergies to pets?

Food allergies?

Allergies to antibiotics or other medications?

An immunodeficiency?

A broken bone?

Are there any other health problems you would like us to be aware of ?

Do you think you'll see a cure for all cancers in your lifetime?

Do you think you'll see a cure for AIDS in your lifetime?

Do you think you'll see a cure for colds and flus in your lifetime?

How long do you think the average American lives?

Do you wear glasses all the time?

For reading only?

For distance only?

Do you wear contact lenses?

Have you had your sight corrected with surgery?

How often do you visit the dentist?

Are any of your teeth capped?

Do you have any dental implants?

Would you say you have a good smile?

Do you want to improve the look of your smile?

Are you taking any prescription medication on a regular basis?

Please list the medications, dosages and frequency of use (i.e. varimycin, 15 mg, 3 times per day):

YOUR EDUCATION

In what section(s) of the country did you attend elementary school?

Middle school?

High school?

What type of high school curriculum did you pursue?

Who was your favorite high school teacher, and why? Just a few words are fine.

What was your favorite subject in High School?

Did you complete high school?

YOUR POSTSECONDARY EDUCATION [where applicable]

Where did you attend college?

Did you complete an associate's or bachelor's degree?

Your degree?

Your major?

Your year of graduation (“Class of . . . ”)?

Did you take longer than the customary four years to complete your degree?

Did part of your course of studies take place at an outside campus or abroad? If so, where?

Did you attend any graduate school for a master's degree?

Did you complete the degree?

Where did you attend college?

Your degree?

Your major?

Year of completion:

Did you take longer than the customary four years to complete your degree?

For what reason?

Did you attend any graduate school for a doctorate, medical or law degree?

Did you complete the degree?

Where did you attend college?

Your degree?

Your major?

Year of completion:

Did you take longer than the customary four years to complete your degree?

For what reason?

Who was your favorite college professor or instructor, and why? Just a few words are fine.

What was your favorite subject in college?

YOUR MILITARY SERVICE [where applicable]

What were or are the dates of your military service?

In what branch?

What is you present rank/was your rank when you left the military?

Are you in the National Guard? The Reserve?

What kind of discharge did you receive?

What skills did you learn in the military?

Did you serve in a combat situation or in support of a combat situation?

Were you wounded in action?

How do you feel about your military experience?

Did your military experience help you to mature?

Do you miss being in the military?

How about the volunteer fire or ambulance service in your town?

YOUR LEGAL/ACCOUNTING NEEDS

Have you ever hired a lawyer?

For what purpose or purposes?

Starting a company

Divorce

Other lawsuit or litigation

Sale or purchase of real estate

Review or draft an employment contract

Have you assigned power of attorney in the event you are incapacitated?

Do you have an organ donor card or authorization?

Do you have a will?

Have you developed an estate plan?

Do you have an accountant?

For what purpose or purposes?

Tax preparation

Investment advice and planning

Other business-related services

Do you have a copy of your birth certificate?

What is your place of birth?

Do you have a baptismal certificate or other certification of religious ceremony 9other than matrimonial)?

YOUR LIFESTYLE

When you were growing up did you have pets?

What pets did you have?

Do you currently own pets?

What types, and how many of each?

Does your community require pets to be licensed?

Which of your pets are licensed? What is the expiration date on the license(s)?

Do you have a favorite bird, perhaps one you see in the yard on occasion?

When you were growing up, did you have your own room, or did you share with others?

Have you ever lived outside the home with a roommate or roommates?

Were you ever a member of the Cub Scouts or Brownies?

Boy Scouts or Girl Scouts?

Have you ever been sailing on a lake or the ocean?

Have you ever gone to Las Vegas or another city to gamble?

Are you registered to vote?

If so, what is your party affiliation: (GOP, Dem, Ind, Reform, Libertarian)?

How would you describe your political values?

Do you know the name of your Congressperson?

If so, please enter his or her name here:

Is he or she a Republican, Democrat or Independent?

Do you know who your United States Senators are?

If so, enter their names and political party (if you know) here:

Do you name the name and party of your Governor?

Do you now who your State Assemblyman or Representative is?

If you remember his or her name, enter it here:

Do you know who your State Senator is?

If you remember his or her name, enter it here:

Do you know who your Mayor or senior town official is?

If you remember his or her name, enter it here:

How about the Police Chief?

Fire Chief?

School Board Chairman or senior education official?

Have you ever ridden along in a police car in your town?

Would you like to do that?

Have you ever attended a town or city meeting?

Have you ever been in the audience for a talk show?

Have you ever attended a play or musical?

Have you ever attended a concert?

Do you go to a hairdresser or stylist?

Do your hair at home yourself?

Men, do you go to a regular barber, or a stylist when you get your hair cut.?

How much do you pay for an average visit to the barber or hair stylist?

How many plants would you estimate you have in your home right now?

Do you have a relative who is your “favorite?”

What is the longest vacation that you've ever taken?

Would you rather buy nothing than buy cheap things?

Who are your best friends?

What are their birthdays?

What color are your eyes?

How tall are you?

How much do you weigh (no cheating!)?

How much would you like to weigh?

What size shoe do you wear (please be specific about the width!)?

Ladies: what size skirt?

Men: what is your waist measurement?

How about the length of your inseam for trousers and slacks?

When you buy a golf or polo shirt, what size do you normally purchase?

When you buy slacks or jeans, what size do you normally purchase?

How about hat size? You may not know it, but if you have a tape measure, just give us the size of your

head at mid brow.

How about neck size? Could you measure that?

What about sleeve length for shirts and blouses?

Do you prefer your shirts or blouses starched?

How about jacket size for men?

Ladies, do you wear stockings or panty hose?

Do you prefer one or the other?

Any special brand that you prefer?

Could you measure your wrist size for us (you never know)?

Men, do you buy your t-shirts (underwear) a size smaller than other tees and polo shirts?

Are you allergic to any fabrics—or dislike some fabric enough to say you're allergic to it?

What's you favorite brand of sneaker or running shoe?

How about shoes—do you only buy all leather shoes—including leather soles?

Do you buy all leather uppers with crepe or rubber soles?

Do you own an umbrella or umbrellas? What type(s)?

Do you own a ball gown or other formal dress for special evenings?

Do you wear suits to work?

Does your place of employment have a dress code?

Are you required to wear suits to work?

Do you have to wear work clothes or rugged clothing while on the job?

Are you required to wear a uniform to work? If so, how many complete uniforms do you own?

Are you required to wear safety gear while working?

Does your company reimburse you to any extent for clothing or uniforms you are required to wear?

Does your union reimburse you to any extent for clothing or uniforms you are required to wear?

Does your place of employment have a “casual Fridays” policy?

How about ties—what style of tie would you consider wearing?

Men, do you have a favorite brand of underwear? What style? How about color?

Do you prefer all cotton underwear or another fabric?

Do you wear cufflinks?

If so, do you own more than one pair of cufflinks?

Are they solid gold, solid silver, gold-plated, silver-plated, knotted silk, or other material?

What brand of wristwatch is your favorite?

What brand of wristwatch would you like to own if money was no object?

How many pairs of shoes do you own?

Would you say your closet is:

Ladies, what about bra size?

Do you have a favorite bra manufacturer?

What about socks? Tell us about your preferences?

Do you often wear shorts in the summer?

Do you own exercise clothing?

Ski wear?

Skateboarding wear?

A bicycle helmet?

A motorcycle helmet?

Elbow guards?

Knee guards?

Wrist guards?

Have you ever had your clothing made to order by a tailor or seamstress?

Do you have any of your clothing dry cleaned? How much do you spend per month on dry cleaning?

Do you send out shirts or blouses to be laundered?

How do you spend your weekends?

At home

Weekend home

Visiting family

Visiting friends

Weekend travel/getaway

Camping

Wilderness adventure/whitewater rafting/other outdoor adventure activities

Weekend cruise

Outdoor sports (sailing, swimming, skiing, etc.)

How do you spend your vacation time?

At home

Visiting family

Visiting friends

Visiting theme parks

Wilderness adventure/whitewater rafting/other outdoor adventure activities

Taking an ocean cruise

Going to the beach

Going sailing

Going to a vacation resort

Visiting casino resorts

Visiting big cities

Travel abroad

Do you travel to warm climates in winter?

Do you travel to cool climates in the summer?

Would you say you are “well traveled” in the United States?

How about overseas?

Do you like to fly?

Do you like to cruise on ships?

Do you like rail travel?

If you could choose, how would you get to someplace far away?

How many times have you been to Europe?

Asia?

South America?

Africa?

The Middle East?

Russia?

China?

Canada?

Mexico?

Central America?

India?

Australia/New Zealand?

Have you ever been on a cruise?

How many times?

Have you ever been on an airplane?

How many times?

Have you ever stayed at a luxury hotel?

How many times?

Have you ever stayed at a youth hostel?

How many times?

Have you ever stayed at a small inn or bed and breakfast?

How many times?

Have you ever traveled by plane on business?

How many times?

Have you ever traveled by rail on business?

How many times?

Have you ever stayed at a business hotel or conference center?

How many times?

Does your job permit you a travel expense account or reimburse travel expenses, including hotel, meals

and transportation?

What color are the walls in your living room?

What color are the walls in your bath?

What color are the walls in your kitchen?

What color is your house painted generally?

Of what material is your house constructed?

What material is used to cover the roof?

Do you have air conditioning?

What type?

What brand?

How many units and what BTU rating?

What is your favorite color?

If you were going to leave your spouse, how would you choose to do it?

What religious tradition(s) were you raised in?

What is your present religion?

What is the religion of your father?

What is the religion of your mother?

Are you and your spouse currently members of the same religion?

What religious tradition(s) are your children being raised in?

How often do you attend a house of worship?

Is anyone in your family a member of the clergy?

Does anyone in your family act as a lay minister or a leader of part of religious services?

Do you regularly read the religious book(s) of your faith?

How often?

Do you subscribe to religious magazines, newspapers, newsletters or other periodicals?

Which ones?

How much money do you contribute to your house of worship per year?

Have you ever sent money to a television ministry?

Have you done so in the last year? If so, how much?

Did you graduate with honors in any school you attended?

Were you a member of an honor society in high school or college?

Did you join a school-affiliated sorority or fraternity in high school or college?

Did you join a non-school-affiliated secret society in high school or college?

What would you say your overall grade point average in high school was?

What would you say your overall grade point average in college was?

Have you ever regretted attending school?

How many magazines do you subscribe to?

Which magazines do you subscribe to?

Do you prefer reading printed editions of magazines to their online equivalents?

How about the newspaper—do you read the newspaper every day?

Which newspaper(s) do you read?

Is it delivered?

What section(s) do you read?

Front page

World news

National news

Local news

Politics/government

Sports

Arts/Entertainment

Books

Weather

Business

Science/Technology

Computers

Nature

Food

Health

Style

Crossword puzzle

Comics

Classifieds

Do you regularly (more than once a week) read any newspapers on the Internet/World Wide Web only?

Which one(s)?

Do you work outside the home?

Do you work from your home?

Do you “telecommute”? If so, how many days per week on average?

Do you often devote time to charities?

Do you contribute regularly to charities?

Do you contribute regularly to your church, synagogue or mosque?

Do you contribute to Public Television?

Are you a member of any organizations with a special interest or focus, such as the Sierra Club or

National Rifle Association?

Have you ever volunteered at a homeless shelter or kitchen?

Do you think the United States Constitution is sacrosanct—in a comparable manner

to, for example, the Ten Commandments?

What do you think of President Clinton?

What did you think of President Bush?

President Ford?

President Nixon?

President Reagan?

President Carter?

President Kennedy?

President Franklin Roosevelt?

President Eisenhower?

President Truman?

Newt Gingrich?

Robert Kennedy?

Joe McCarthy?

General Douglas MacArthur?

J. Edgar Hoover?

Do you like to garden?

What sort of gardening do you like to do?

Flower gardens

Vegetable gardens

Landscaping

How about cooking—do you do most of the cooking in your home?

If so, do you enjoy it?

If not, would you rather eat out every night?

Speaking of food, what would you say your favorite food is?

Do you enjoy steak?

Veal?

Pork?

Lamb?

How about fish?

Do you limit your meat intake?

Are you a vegetarian?

Chicken?

Turkey?

Seafood such as lobster or crabs?

Desserts?

What is your favorite dessert?

How about vegetables?

Potatoes?

Corn on the cob?

Broccoli?

Asparagus?

Tomatoes?

Salads?

Fruit?

Bananas?

Oranges?

Strawberries?

Grapefruit?

Raspberries?

Prunes?

Blueberries?

Do you eat breakfast cereal [hot or cold]?

Do you drink milk at least once a day?

Do you drink coffee?

How much?

What type of coffeemaker do you use?

What type of coffee do you usually buy for your home?

How often do you buy fast food?

What is your favorite fast food item?

How often do you eat at restaurants?

Do you like Italian food?

Chinese food?

Indian food?

French cuisine?

Russian food?

Japanese cuisine?

Eastern European cuisine?

Mexican food?

Thai food?

Do you order pizza?

Other take-out or delivery food?

How about vitamins—do you take one or more vitamin supplements every day?

Do you take other nutritional supplements?

Do you smoke cigarettes?

How often?

Do you smoke cigars?

How often?

Do you smoke a pipe?

How often?

Do you drink beer?

What is your preferred brand?

Have you ever tried “microbrewed” beer?

Have you ever dined at a brewery that makes its own beer?

Do you like wine?

Do you know much about wine?

What is your favorite variety of wine?

Do you enjoy drinks containing distilled spirits such as whiskey, brandy, gin or vodka?

Do you have a favorite type of “hard liquor” ?

A favorite brand?

Have you ever tried cognac?

Armagnac?

Bourbon?

Single-malt scotch?

Flavored vodka?

Have you ever committed a crime—even a petty crime like stealing a candy bar or cheating on your taxes

just a wee bit?

Have you ever been found guilty in a court?

Have you ever been sentenced to a fine?

Probation?

Jail?

Would you say your country is moving in the right direction?

Would you vote for George W. Bush Jr. right now for President?

How about Al Gore?

Is there anyone else you might vote for right now for President?

Are you happy with a Republican-controlled House of Representatives?

How about a Republican-controlled Senate?

Do you think that electing a Republican as President will make it easier for Congress to pass better laws?

When you see a policeman, would you say you feel a bit insecure?

Do you think you earn enough money to be happy?

Are you constantly on a diet?

Are you losing your hair?

Do you take sedatives in order to sleep?

Have you ever been to a Bar Mitzvah?

How about a Christening?

A Confirmation?

A bris?

Do you sometimes feel afraid for no reason?

Do you engage in hazardous or dangerous sports?

How is your driving record?

How frequently do you get parking tickets?

How frequently do you get stopped for speeding or other driving infractions?

Would you say you driver faster or slower than most?

How much driving do you do on highways?

Local streets?

Roads that are unpaved or poorly maintained?

How many miles of driving per month do you and your family do?

What color is your hair?

Is that your natural color?

Do you have regular manicures?

Have you ever worn a wig or a toupee on a regular basis?

Do you often wear shoes without socks?

YOUR RECREATION

SPORTS

Which of the following sports or activities do you regularly participate in?

Baseball

Softball

Football

Basketball

Volleyball

Hockey

Bowling

Jogging

Running

Bicycling

Fishing

Hunting

Golf

Tennis

Swimming

Skateboarding

Ice Skating

Rollerblading

Skiing

Do you go to a health club or gym regularly?

How many times per week?

What facilities or machines do you use the most?

Aerobics classes

Spinning

Bicycles

Treadmill

Nautilus

Pilates

Free weights

Tae bo

Tai chi

Climbing wall

Yoga

Karate or other martial arts

Do you have a personal trainer? At home? At the gym?

Do you consider yourself an athlete?

Do you/did you play sports in middle or high school?

Which ones? [Intramural/varsity]

Baseball

Softball

Football

Basketball

Volleyball

Hockey

Field Hockey

Lacrosse

Soccer

Cross-country

Gymnastics

Other:

Do you/did you play sports in college?

Which ones? [Intramural/varsity]

Baseball

Softball

Football

Basketball

Volleyball

Hockey

Field Hockey

Lacrosse

Soccer

Cross-country

Gymnastics

Other:

Do you know how to sail?

Do you know how to ski?

Do you know how to canoe or kayak?

Have you ever been whitewater rafting?

Have you ever tried mountain climbing or rappelling?

Have you ever driven a jet ski?

Have you ever taken a flying lesson?

What would you say the most dangerous sport is?

YOUR RECREATION

TELEVISION

How many televisions of each type are there in your household:

High Definition Projection

Projection

High Definition Rear Projection

High Definition Direct View (Wide Screen)

Standard Screen 36″ or greater

Standard Screen 30″-35″

Standard Screen 27″-29″

Standard Screen 25″-26″

Standard Screen 23″-24″

Standard Screen 20′-22″

Standard Screen 15″-19″

Standard Screen 12″-14″

Smaller than 12″ screen

How many hours a week is your television on?

How many hours a week do you actually watch broadcast television?

What is your favorite genre of programming?

Which of the following genres do you watch, and how many hours per week?

Morning news shows

Daytime talk shows

Daytime dramas

Game shows

Cable business channels

Cable news

Cable sports

Entertainment news

Prime-time/syndicated comedy

Prime-time/syndicated drama

Prime-time/syndicated action

Prime-time/syndicated news

Home/garden/cooking

Music/concerts/MTV

Cable history/documentary/reality programming

Movies/cable film channels

Wrestling

Baseball

Football

Basketball

Hockey

Golf

Cartoons/children's programming

Do you have a TV in your office?

What is it used for? (video presentations/monitoring cable business stations/monitoring news channels/MTV/other)

How do you feel about commercials?

Have you ever watched a pay-per-view event?

Is pay-per-view available on your cable or satellite system?

How often do you watch the following types of pay-per-view programs?

Boxing

Other sports events

Wrestling

Movies

Have you ever consulted an Internet television reference site (such as www.imdb.com)?

Have you ever surfed to a television network's official web site?

Have you ever surfed to a television program's official web site?

Have you ever surfed to an unofficial or fan site for a television program?

Name your three favorite television celebrities:

Name your current favorite television program:

Name your three favorite television program of all time:

Do you think that the Internet will change television as we know it?

Would you pay to be able to see your favorite programs on demand, without commercial interruption?

MOVIES

In addition to broadcast and pay-per-view movies, do you rent movies?

How often?

Do you own more than one VCR?

If so, do you use it to make copies of movies?

Do you go to movie theatres?

If so, how often?

What genres do you prefer?

Comedy

Drama

Romantic comedy

Action

Drama

Science Fiction

Horror

Family films

Animated/Feature-length cartoons

Foreign films

Documentary

Adult films

Name your three favorite actors or actresses:

Name your favorite director or filmmaker:

Name your three all-time favorite films:

Do you watch At the Movies, Sneak Previews or other cinema-related television programs?

Do you own any film reference guides (such as Halliwell's Film Guide)?

Have you ever consulted an Internet film reference site (such as www.imdb.com)?

Do you feel that film audiences have become more inconsiderate since the advent of home video?

Have you ever surfed to a film's official web site? Before the film opened?After the film opened?

Do you own a DVD player?

Do you own any DVDs?How many?

How many prerecorded VHS tapes do you buy per year? How many blank VHS tapes per year?

Do you own a home theater system (audio)?

If not, would you like to have a home theater system?

INTERNET

How many hours a week do you spend on the Internet?

How many hours do you spend per week on each of the following:

Chat/Instant messaging

Email

Discussion and Usenet groups/bulletin boards

World Wide Web

How do you use the Web?

Read news stories

Sports information

Weather

Download MP3s

Adult sites

Games

Try new software

Do you think the Internet will change the world?

What kinds of things do you think you CANNOT purchase over the Internet at this time?

What kinds of things would you like to purchase over the Internet in future?

BOOKS

How many books do you read per month?

What genres do you purchase most?

Current Bestsellers

Art/Architecture

Biographies/Memoirs

Business/Investing

Children's Books

Computers/Internet

Cooking/Food/Wine

Current Events & Opinion/Politics

Entertainment

History

Home/Garden/How-To

Horror

Literature/Fiction

Mystery/Suspense

Nonfiction

Outdoors/Sports

Parenting/Families

Professional/Technical

Religion/Spirituality

Romance

Science/Nature

Science Fiction/Fantasy

Self-Help/Health, Mind and Body

Sports

Teens

Travel

How often do you purchase books from:

Independent book store

Chain book store/book superstore (Borders, Barnes & Noble, etc.)

Convenience store/pharmacy/grocery store

Discount store (Wal-Mart, K-Mart, etc.)

Online store

Used book store/Book exchange

How many books do you own? Hardcover? Paperback?

Which do you prefer: hardcover or paperback editions?

Do you own an encyclopedia?

Do you own a dictionary?

Name your three favorite authors:

Name your three all-time favorite books:

Do you use reference books more than once a month?

Have you ever used an online encyclopedia, dictionary or other reference site?

Have you ever used an interactive CD-ROM encyclopedia, dictionary or other reference work?

MUSIC

How many hours per week do you listen to music in your home?

How many hours do you listen to the radio?

To your own recordings?

Can you listen to music in your place of work?

Can you listen to the music of your choice in your place of work?

What genres do you listen to most?

Alternative

Blues

Broadway/Musical Theater

Christian Pop/Rock

Classical

Country

Dance/DJ/House

Folk

Gospel

Heavy Metal

Traditional Jazz

New Age

Opera/Classical Vocal

Pop

R&B/Soul

Rap & Hip-Hop

Rock

Soundtrack/Film Music

Swing/Big Band

Vocal

How many CDs do you own?

How many CDs do you buy in an average month?

How many cassettes do you own?

Of those, how many have you made yourself from other recordings?

How many prerecorded cassettes do you buy per month? How many blanks?

Do you still play LPs?

How many do you own?

How many do you buy per month?

Which of the following do you own:

Tabletop radio

Walkman

Discman (portable CD player)

“Boom box”

Mini-system (stereo)

Mini-system (home theater)

Component system (receiver or preamp/amp, speakers)

Component CD player

Component CD/R or CD/RW player/

Component AM/FM tuner

Component cassette player/recorder

Component DVD player

Component DAT player/recorder

Component open-reel

Satellite receiver

Component turntable

Record player

Have you ever downloaded music from the Internet?

In which format(s): aiff, .wav, .mp3, RealAudio, Liquid Audio, other.

Is your computer equipped with high-quality sound card and speakers?

How would you rate the ease of use of music software and the internet?

Is your computer wired into your stereo system or home theater?

Have you ever used .midi files?

Do you play a musical instrument regularly? What instrument?

Have you ever played a musical instrument regularly? Which one(s)?

Did you ever take private music lessons?

Have you ever written a song?

Can you read musical notation?

Do you think prerecorded music is too expensive, priced just right, or is too cheap?

Where do you buy most of your music?

Music store

Discount store

Department store

Online

Have you ever been a member of a mail-order record or CD club?

Which one(s)? BMG Music Service, Columbia House, Musical Heritage Society, other

Are you presently a member of a mail-order music service?

Have you ever bought a record or CD exclusively available through a TV offer?

Have you ever purchased a new CD online?

Have you ever traded CDs or bought a used CD from a Usenet post or at auction online?

YOUR SHOPPING HABITS

Do you shop for quality, price or both?

If you shop for quality only—is price still an issue?

If you could have an assistant do one chore for you—what would it be?

How frequently do you shop for groceries?

Do you regularly (i.e. once a month or more) buy food from a greengrocer?

Butcher shop?

Deli?

Bakery or pastry shop?

Coffee shop?

Do you use coupons at the grocery?

How about other shopping—how often do you shop sales?

Do you think you get a better deal on clothing at outlet stores or at regular department stores when things are on sale?

Do you read Consumer Reports?

Another consumer guide?

Do you look for sale ads in your local newspaper?

Have you ever had groceries delivered?

Dry cleaning?

If someone in your area agreed to deliver fresh bread to you every day, would you consider subscribing to that service?

REMINDERS

Do you want to be automatically reminded of birthdays, anniversaries and other important occasions?

What do you want SurfAssured to do for you?

1. A method of communicating information comprising the steps of:
forming a demographic profile for at least one of a plurality of consumers;
receiving an inquiry from said at least one of said plurality of consumers;
retrieving data relating to said inquiry;
filtering said data relating to said inquiry based on said demographic profile associated with said at least one of said plurality of consumers;
customizing a response to said inquiry according to said demographic profile associated with said at least one of said plurality of consumers; and
transmitting said response to said at least one of said plurality of consumers.

2. The method of claim 1, wherein the step of forming a demographic profile further includes the steps of:
sending an initial questionnaire to said at least one of said plurality of consumers;
receiving a reply to said initial questionnaire; and
incorporating said reply to said initial questionnaire into said demographic profile of said at least one of said plurality of consumers .

3. The method of claim 2, further comprising the steps of
sending at least one subsequent questionnaire to said at least one of said plurality of consumers;
receiving a reply to said at least one subsequent questionnaire; and
incorporating said reply to said subsequent questionnaire into said demographic profile of said at least one of said plurality of consumers.

4. The method of claim 1, wherein the step of forming a demographic profile further includes the step of:
incorporating at least one inquiry from said at least one of said plurality of consumers into said demographic profile of said at least one of said plurality of consumers.

5. The method of claim 1, wherein the plurality of consumers are coupled to a network for engaging in communications via said network, and wherein the step of forming a demographic profile further includes the steps of:
monitoring said communications via said network of said at least one of said plurality of consumers; and
incorporating said communications via said network of said at least one of said plurality of consumers into said demographic profile of said at least one of said plurality of consumers.

6. The method of claim 1, wherein the inquiry relates to an article said at least one of said plurality of consumers desires to purchase.

7. The method of claim 6, wherein said data relating to said inquiry is retrieved from a database containing information relating to said article.

8. The method of claim 6, further comprising a network having a plurality of information sources, and said data relating to said inquiry is retrieved from at least one of said plurality of information sources containing information relating to said article.

9. The method of claim 6, wherein said data relating to said inquiry includes a description of said article.

10. The method of claim 6, wherein said data relating to said inquiry includes an advertisement relating said article.

11. The method of claim 6, wherein said data relating to said inquiry includes a supplier of said article.

12. A method for a consumer to purchase an article, said consumer being in network communications with a trusted entity having a credit line, said consumer having a demographic profile accessible by said trusted entity, said method comprising the steps of:
receiving an inquiry relating to said article from said consumer;
transmitting a response to said inquiry to said consumer based on said demographic profile of said consumer;
receiving a purchase request from said consumer to purchase said article;
clearing said purchase;
purchasing said article from a supplier of said article using said credit line of said trusted entity; and
sending said article to said consumer.

13. The method of claim 12, wherein said customer has a credit amount and said article has a purchase price, and the step of clearing said purchase comprises the steps of:
determining whether said credit amount of said consumer is at least equal to said purchase price of said article; and
transferring a payment equal to said purchase price from said credit amount to said trusted entity if said credit amount of said consumer is at least equal to said purchase price.

14. The method of claim 12, wherein said response includes a reference to said supplier of said article and said purchase request identifies said supplier.

15. The method of claim 12, wherein said supplier of said article is selected by said trusted entity based on said demographic profile of said consumer.

16. The method of claim 12, wherein said consumer has a unique identity and the step of purchasing said article includes the step of:
sending said supplier a purchase order for said article without disclosing to said supplier said unique identity of said consumer.

17. The method of claim 12, wherein the step of sending said article comprises the steps of:
directing said supplier to forward said article to a secure shipping entity;
disclosing to said secure shipping entity said identity of said consumer; and
directing said secure shipping entity to send said article to said consumer.

18. A method for a consumer to purchase an article, said consumer having a demographic profile, said consumer being in network communications with a trusted entity having a credit line, said method comprising the steps of:
receiving an inquiry relating to said article from said consumer;
transmitting a response to said inquiry to said consumer based on said demographic profile of said consumer;
receiving a purchase request from said consumer to purchase said article;
publishing a request for quotation to a plurality of suppliers of said article;
receiving a plurality of offers to sell said article;
providing said consumer a comparison of said plurality of offers;
receiving from said consumer an authorization to purchase said article from one of said plurality of suppliers;
clearing said purchase;
purchasing said article from said one of said plurality of suppliers using said credit line of said trusted entity; and
sending said article to said consumer.

19. The method of claim 18, wherein said step of providing said consumer a comparison includes the steps of:
determining which of said plurality of offers are best offers; and
filtering said plurality of offers based on said demographic profile.

20. The method of claim 18, wherein the step of receiving a plurality of offers to sell said article further comprises the steps of:
publishing a counterbid to at least one of said plurality of suppliers; and
receiving at least one counteroffer in response from said counterbid; and the step of providing said consumer a comparison includes the step of:
providing said consumer a comparison of said plurality of offers and said at least one counteroffer.

21. The method of claim 20, where said counterbid is formed by reducing at one of said plurality of offers by a discount rate.

22. A method of distributing advertising information, comprising the steps of:
forming a demographic profile for each of a plurality of consumers;
receiving said advertising information from an advertising entity;
selecting at least one of said plurality of consumers to receive said advertising information based on said demographic profile associated with said at least one of said plurality of consumers;
constructing an advertising message from said advertising information according to said demographic profile associated with said at least one of said plurality of consumers; and
transmitting said advertising message to said at least one of said plurality of consumers.

23. The method of claim 22, wherein the step of selecting includes the step of:
selecting at least one of said plurality of consumers to receive said advertising message based on a request for information made by said at least one of said plurality of consumers.

24. A method of providing a supplier of an article with a qualified purchaser, comprising the steps of:
forming a demographic profile for each of a plurality of consumers;
receiving an inquiry relating to said article from said consumer; and
transmitting a response to said inquiry to said consumer based on said demographic profile of said consumer, said response including a reference to said supplier of said article.

25. A system for communicating information, comprising:
a network;
a trusted entity server coupled to said network; said trusted entity server being coupled to a storage device containing data; and
a plurality of consumer devices coupled to said network and in communication with said trusted entity server; each of said consumer devices being operated by a consumer; each of said consumers having a demographic profile stored on said storage device;
wherein when said trusted entity server receives an inquiry from one of said consumers via one of said consumer devices, said trusted entity server retrieves from said storage device a portion of said data that is related to said inquiry and transmits a response to said inquiry to said one of said consumers using said portion of data and customizing said response based on said demographic profile of said one of said consumers.

26. The system of claim 25, further comprising a plurality of information sources coupled to said network and in communication with said trusted entity server; said information sources containing information;
wherein when said trusted entity server receives said inquiry from said one of said consumers, said trusted entity server retrieves from said information sources a portion of said information that is related to said inquiry and transmits a customized response to said inquiry to said one of said consumers using said portion of information and customizing said response based on said demographic profile of said one of said consumers.

27. The system of claim 25 wherein said trusted entity server has a credit line, and further comprising:
at least one supplier having a supplier server coupled to said network and in communication with said trusted entity server, said at least one supplier capable of receiving a purchase order for an article and causing said article to be delivered to one of said plurality of consumers; and
a purchase request generated by said one of said consumers for said article
wherein said response to said inquiry includes information regarding said article and a reference to said at least one supplier and wherein when said trusted entity server receives said purchase order, said trusted entity server purchases said article from said at least one supplier using said credit line and said at least one supplier causes said article to be delivered to said one of said plurality of consumers.

28. The system of claim 27, wherein said one of said plurality of consumers has a credit amount and said article has a purchase price, and further comprising:
a financial clearinghouse coupled to said network and in communications with said trusted entity server;
wherein when said trusted entity server receives said purchase order, said trusted entity server communicates with said financial clearinghouse to determine whether said credit amount is at least equal to said purchase price and to receive a payment equal to the purchase price from said one of said plurality of consumers.

29. The system of claim 25, wherein trusted entity server includes a private data server coupled to a secure storage device and an anonymous data server coupled to said storage device; each of said plurality of consumers having contact information wherein said contact information is stored on said secure storage device.

30. The system of claim 27, wherein said one of said plurality of consumers has shipping information stored on said storage device coupled to said trusted entity server and further comprising:
a transshipping depot coupled to said at least one supplier; and
a secure server coupled to said network and to said transshipping depot, said secure server receiving said shipping information from said trusted entity and communicating said shipping information to said transshipping depot;
wherein when said transshipping depot receives said article from said at least one supplier, said transshipping depot delivers said article to said one of said plurality of consumers using said shipping information.

31. The system of claim 25, wherein each of said consumers have confidential information and said trusted entity server further comprises a private data server and an anonymous data server, wherein said confidential information is stored on said private data server and said demographic profile are stored on said anonymous data server.

32. A method of performing surveys comprising the steps of:
forming a demographic profile for each of a plurality of consumers, said demographic profiles including preferences;
receiving a survey request having a question regarding preferences;
scanning at least a portion of said demographic profiles to determine an answer to said question based on said preferences; and
transmitting said answer to said survey request.

33. The method of claim 32, wherein said survey request has a demographic limitation and said at least a portion of said demographic profiles are said demographic profiles meeting said demographic limitation.

34. A method of performing life management, comprising the steps of:
forming a demographic profile for each of a plurality of consumers;
recommending an article to at least one of said consumers based on said demographic profile;
receiving a request to purchase said article from said consumer; and
purchasing said article on behalf of said consumer.
